(19) United States
(12) Patent Application Publication
(10) Pub. No.: US 2014/0132605 A1
(43) Pub. Date: May 15, 2014

(54) SYSTEM, APPARATUS, AND METHOD FOR IMAGE PROCESSING AND MEDICAL IMAGE DIAGNOSIS APPARATUS

(71) Applicants: Toshiba Medical Systems Corporation, Otawara-shi (JP); Kabushiki Kaisha Toshiba, Minato-ku (JP)

(72) Inventors: Shinsuke TSUKAGOSHI, Nasushiobara-shi (JP); Takashi Tsutsumi, Utsunomiya-shi (JP); Yoshinori Uebayashi, Utsunomiya-shi (JP); Michito Nakayama, Utsunomiya-shi (JP); Yoshiaki Yaoi, Nasushiobara-shi (JP); Hideki Tajima, Nasushiobara-shi (JP)

(73) Assignees: Toshiba Medical Systems Corporation, Otawara-shi (JP); Kabushiki Kaisha Toshiba, Minato-ku (JP)

(21) Appl. No.: 14/158,352

(22) Filed: Jan. 17, 2014

Related U.S. Application Data
(63) Continuation of application No. PCT/JP2012/068371, filed on Jul. 19, 2012.

(30) Foreign Application Priority Data
Jul. 19, 2011 (JP) 2011-158226

(51) Int. Cl. G06T 15/08

(52) U.S. Cl. CPC G06T 15/08
USPC 345/424

(57) ABSTRACT

An image processing system according to an aspect includes a receiving unit, an estimating unit, a rendering processing unit, and a display controlling unit. The receiving unit receives an operation to apply a virtual force to a subject shown in a stereoscopic image. The estimating unit estimates positional changes of voxels contained in volume data, based on the force received by the receiving unit. The rendering processing unit changes positional arrangements of the voxels contained in the volume data based on a result of the estimation by the estimating unit and newly generates a group of disparity images by performing a rendering process on post-change volume data. The display controlling unit causes a stereoscopic display apparatus to display the group of disparity images newly generated by the rendering processing unit.

### CROSS-REFERENCE TO RELATED APPLICATIONS

This application is a continuation of International Application No. PCT/JP2012/068371, filed on Jul. 19, 2012 which claims the benefit of priority of the prior Japanese Patent Application No. 2011-158226, filed on Jul. 19, 2011, the entire contents of which are incorporated herein by reference.

### FIELD

Embodiments described herein relate generally to a system, an apparatus, and a method for image processing and a medical image diagnosis apparatus.

### BACKGROUND

Conventionally, a technique is known by which an image capable of providing a user who uses an exclusive-use device such as stereoscopic glasses with a stereoscopic view is displayed, by displaying two images taken from two viewpoints on a monitor. Further, in recent years, a technique is known by which an image capable of providing even a glass-free user with a stereoscopic view is displayed, by displaying images (e.g., nine images) taken from a plurality of viewpoints on a monitor while using a light beam controller such as a lenticular lens. The plurality of images displayed on a monitor capable of providing a stereoscopic view may be generated, in some situations, by estimating depth information of an image taken from one viewpoint and performing image processing while using the estimated information.

Incidentally, as for medical image diagnosis apparatuses such as X-ray Computed Tomography (CT) apparatuses, Magnetic Resonance Imaging (MRI) apparatuses, and ultrasound diagnosis apparatuses, such apparatuses have been put in practical use that are capable of generating three-dimensional medical image data (hereinafter, “volume data”). Such medical image diagnosis apparatuses are configured to generate a display-purpose planar image by performing various types of image processing processes on the volume data and to display the generated image on a general-purpose monitor. An example of such a medical image diagnosis apparatus is configured to generate a two-dimensional rendering image that reflects three-dimensional information about an examined subject (hereinafter, “subject”) by performing a volume rendering process on volume data and to display the generated rendering image on a general-purpose monitor.

### BRIEF DESCRIPTION OF THE DRAWINGS

FIG. 1 is a drawing for explaining an exemplary configuration of an image processing system according to a first embodiment;

FIG. 2A is a first drawing for explaining an example of a stereoscopic display monitor that realizes a stereoscopic display by using two-eye disparity images;

FIG. 2B is a second drawing for explaining the example of the stereoscopic display monitor that realizes the stereoscopic display by using the two-eye disparity images;

FIG. 3 is a drawing for explaining an example of a stereoscopic display monitor that realizes a stereoscopic display by using nine-eye disparity images;

FIG. 4 is a drawing for explaining an exemplary configuration of a workstation according to the first embodiment;

FIG. 5 is a drawing for explaining an exemplary configuration of a rendering processing unit shown in FIG. 4;

FIG. 6 is a drawing for explaining an example of a volume rendering process according to the first embodiment;

FIG. 7 is a drawing for explaining an example of a process performed by the image processing system according to the first embodiment;

FIG. 8 is a drawing for explaining a terminal apparatus according to the first embodiment;

FIG. 9 is a drawing of an example of a correspondence relationship between a stereoscopic image space and a volume data space;

FIG. 10 is a drawing for explaining an exemplary configuration of a controlling unit according to the first embodiment;

FIG. 11 is a drawing for explaining an example of an estimating process performed by an estimating unit according to the first embodiment;

FIG. 12 is a sequence chart of an exemplary flow in a process performed by the image processing system according to the first embodiment;

FIG. 13 is a drawing for explaining an example of a process performed by an image processing system according to a second embodiment;

FIG. 14 is a drawing for explaining an example of an estimating process performed by an estimating unit according to the second embodiment;

FIG. 15 is a sequence chart of an exemplary flow in a process performed by the image processing system according to the second embodiment;

FIG. 16 is a drawing for explaining a modification example of the second embodiment;

FIG. 17 is a drawing for explaining another modification example of the second embodiment;

FIG. 18 is another drawing for explaining said another modification example of the second embodiment;

FIG. 19 is a drawing for explaining yet another modification example of the second embodiment; and

FIG. 20 is a drawing for explaining yet another modification example of the second embodiment.

### DETAILED DESCRIPTION

An image processing system according to an embodiment includes a receiving unit, an estimating unit, a rendering processing unit, and a display controlling unit. The receiving unit receives an operation to apply a virtual force to a subject shown in a stereoscopic image. The estimating unit estimates positional changes of voxels contained in volume data, based on the force received by the receiving unit. The rendering processing unit changes positional arrangements of the voxels contained in the volume data based on a result of the estimation by the estimating unit and newly generates a group of disparity images by performing a rendering process on post-change volume data. The display controlling unit causes a stereoscopic display apparatus to display the group of disparity images newly generated by the rendering processing unit.

Exemplary embodiments of a system, an apparatus, and a method for image processing and a medical image diagnosis apparatus will be explained in detail, with reference to the accompanying drawings. In the following sections, an image processing system including a workstation that has functions of an image processing apparatus will be explained as an exemplary embodiment. First, some of the terms used in the description of the exemplary embodiments below will be defined. The term “a group of disparity images” refers to a group of images generated by performing a volume rendering process on volume data while shifting the viewpoint position by a predetermined disparity angle at a time. In other words, the “group of disparity images” is made up of a plurality of “disparity images” having mutually-different “viewpoint positions”. The term “disparity angle” refers to an angle determined by two viewpoint positions positioned adjacent to each other among viewpoint positions that have been set for generating a “group of disparity images” and a predetermined position in a space (e.g., the center of the space) expressed by the volume data. The term “disparity number” refers to the number of “disparity images” required to realize a stereoscopic view on a stereoscopic display monitor. Further, the term “nine-eye disparity images” used herein refers to “a group of disparity images” made up of nine “disparity images”. The term “two-eye disparity images” used herein refers to “a group of disparity images” made up of two “disparity images”.

### First Embodiment

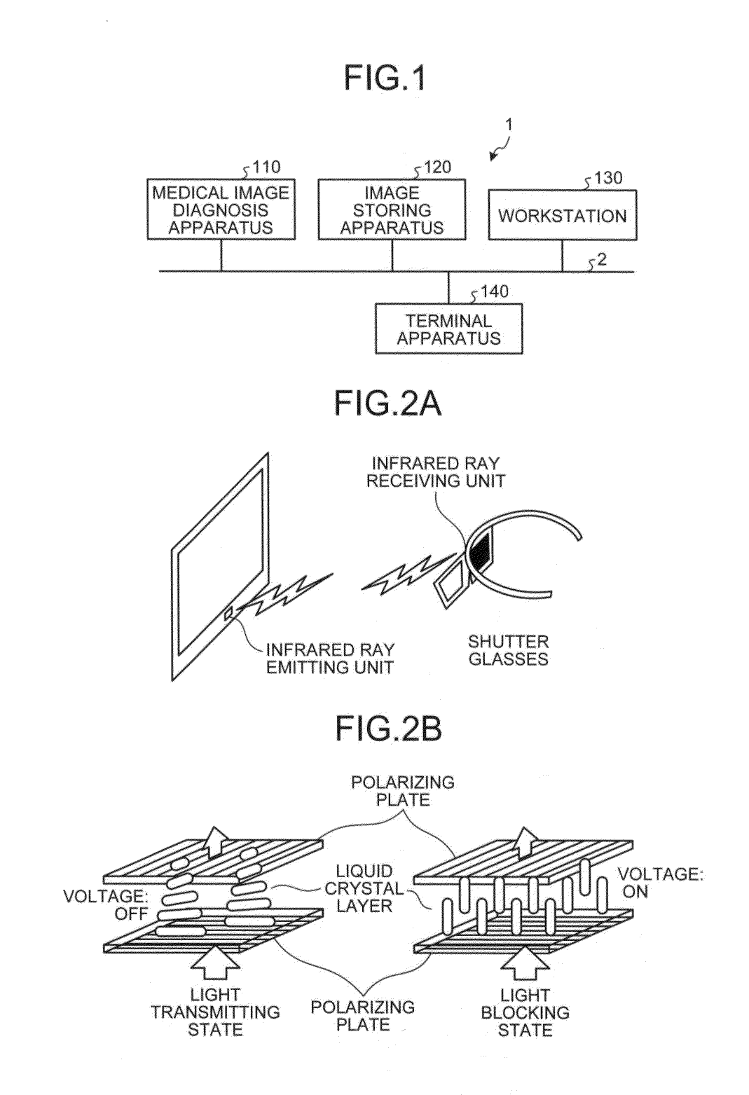

First, an exemplary configuration of an image processing system according to a first embodiment will be explained. FIG. 1 is a drawing for explaining the exemplary configuration of the image processing system according to the first embodiment.

As shown in FIG. 1, an image processing system 1 according to the first embodiment includes a medical image diagnosis apparatus 110, an image storing apparatus 120, a workstation 130, and a terminal apparatus 140. The apparatuses illustrated in FIG. 1 are able to communicate with one another directly or indirectly via, for example, an intra-hospital Local Area Network (LAN) 2 set up in a hospital. For example, if a Picture Archiving and Communication System (PACS) has been introduced into the image processing system 1, the apparatuses send and receive medical images and the like to and from one another according to the Digital Imaging and Communications in Medicine (DICOM) standard.

The image processing system 1 provides a viewer (e.g., a medical doctor, a laboratory technician, etc.) working in the hospital with a stereoscopic image, which is an image the viewer is able to stereoscopically view, by generating a group of disparity images from volume data that is three-dimensional medical image data generated by the medical image diagnosis apparatus 110 and displaying the generated group of disparity images on a monitor capable of providing a stereoscopic view. More specifically, according to the first embodiment, the workstation 130 generates the group of disparity images by performing various types of image processing processes on the volume data. Further, the workstation 130 and the terminal apparatus 140 each have a monitor capable of providing a stereoscopic view and are configured to display the stereoscopic image for the user by displaying the group of disparity images generated by the workstation 130 on the monitor. Further, the image storing apparatus 120 stores therein the volume data generated by the medical image diagnosis apparatus 110 and the group of disparity images generated by the workstation 130. For example, the workstation 130 and the terminal apparatus 140 obtain the volume data and/or the group of disparity images from the image storing apparatus 120, perform an arbitrary image processing process on the obtained volume data and/or the obtained group of disparity images, and have the group of disparity images displayed on the monitor. In the following sections, the apparatuses will be explained one by one.

The medical image diagnosis apparatus 110 may be an X-ray diagnosis apparatus, an X-ray Computed Tomography (CT) apparatus, a Magnetic Resonance Imaging (MRI) apparatus, an ultrasound diagnosis apparatus, a Single Photon Emission Computed Tomography (SPECT) apparatus, a Positron Emission computed Tomography (PET) apparatus, a SPECT-CT apparatus having a SPECT apparatus and an X-ray CT apparatus incorporated therein, a PET-CT apparatus having a PET apparatus and an X-ray CT apparatus incorporated therein, or a group of apparatuses made up of any of these apparatuses. Further, the medical image diagnosis apparatus 110 according to the first embodiment is capable of generating the three-dimensional medical image data (the volume data).

More specifically, the medical image diagnosis apparatus 110 according to the first embodiment generates the volume data by taking images of a subject. For example, the medical image diagnosis apparatus 110 acquires data such as projection data or Magnetic Resonance (MR) signals by taking images of the subject and generates the volume data by reconstructing medical image data on a plurality of axial planes along the body-axis direction of the subject from the acquired data. In an example where the medical image diagnosis apparatus 110 reconstructs medical image data representing 500 images on axial planes, a group made up of pieces of medical image data representing the 500 images on the axial planes serves as the volume data. Alternatively, the projection data itself or the MR signals themselves of the subject resulting from the image taking process performed by the medical image diagnosis apparatus 110 may serve as the volume data.

Further, the medical image diagnosis apparatus 110 according to the first embodiment sends the generated volume data to the image storing apparatus 120. When sending the volume data to the image storing apparatus 120, the medical image diagnosis apparatus 110 also sends additional information such as a subject ID identifying the subject, a medical examination ID identifying a medical examination, an apparatus ID identifying the medical image diagnosis apparatus 110, a series ID identifying the one image-taking process performed by the medical image diagnosis apparatus 110, and/or the like.

The image storing apparatus 120 is a database configured to store therein medical images. More specifically, the image storing apparatus 120 according to the first embodiment receives the volume data from the medical image diagnosis apparatus 110 and stores the received volume data into a predetermined storage unit. Also, according to the first embodiment, the workstation 130 generates the group of disparity images from the volume data and sends the generated group of disparity images to the image storing apparatus 120. Thus, the image storing apparatus 120 stores the group of disparity images sent thereto from the workstation 130 into a predetermined storage unit. By configuring the workstation 130 so as to be able to store therein a large volume of images, the workstation 130 and the image storing apparatus 120 according to the first embodiment illustrated in FIG. 1 may be integrated together. In other words, it is acceptable to configure the first embodiment in such a manner that the volume data or the group of disparity images is stored in the workstation 130 itself.

In the first embodiment, the volume data and the group of disparity images stored in the image storing apparatus 120 are stored while being kept in correspondence with the subject ID, the medical examination ID, the apparatus ID, the series ID, and/or the like. Thus, the workstation 130 and the terminal apparatus 140 are able to obtain a required piece of volume data or a required group of disparity images from the image storing apparatus 120, by conducting a search using a subject ID, a medical examination ID, an apparatus ID, a series ID, and/or the like.

The workstation 130 is an image processing apparatus configured to perform an image processing process on medical images. More specifically, the workstation 130 according to the first embodiment generates the group of disparity images by performing various types of rendering processes on the volume data obtained from the image storing apparatus 120.

Further, the workstation 130 according to the first embodiment includes, as a display unit, a monitor capable of displaying a stereoscopic image. (The monitor may be referred to as a stereoscopic display monitor or a stereoscopic image display apparatus.) The workstation 130 generates the group of disparity images and displays the generated group of disparity images on the stereoscopic display monitor. As a result, an operator of the workstation 130 is able to perform an operation to generate a group of disparity images, while viewing the stereoscopic image that is capable of providing a stereoscopic view and is being displayed on the stereoscopic display monitor.

Further, the workstation 130 sends the generated group of disparity images to the image storing apparatus 120 and/or to the terminal apparatus 140. When sending the group of disparity images to the image storing apparatus 120 and/or to the terminal apparatus 140, the workstation 130 also sends additional information such as the subject ID, the medical examination ID, the apparatus ID, the series ID, and/or the like. The additional information that is sent when the group of disparity images is sent to the image storing apparatus 120 may include additional information related to the group of disparity images. Examples of the additional information related to the group of disparity images include the number of disparity images (e.g., “9”), the resolution of the disparity images (e.g., “466×350 pixels”), information (volume space information) related to a three-dimensional virtual space expressed by the volume data from which the group of disparity images was generated.

The terminal apparatus 140 is an apparatus used for having the medical images viewed by the medical doctors and the laboratory technicians working in the hospital. For example, the terminal apparatus 140 may be a personal computer (PC), a tablet-style PC, a Personal Digital Assistant (PDA), a portable phone, or the like operated by any of the medical doctors and the laboratory technicians working in the hospital. More specifically, the terminal apparatus 140 according to the first embodiment includes, as a display unit, a stereoscopic display monitor. Further, the terminal apparatus 140 obtains the group of disparity images from the image storing apparatus 120 and displays the obtained group of disparity images on the stereoscopic display monitor. As a result, any of the medical doctors and the laboratory technician serving as a viewer is able to view the medical images capable of providing a stereoscopic view. The terminal apparatus 140 may be an arbitrary information processing terminal connected to a stereoscopic display monitor configured as an external apparatus.

Next, the stereoscopic display monitors included in the workstation 130 and the terminal apparatus 140 will be explained. Commonly-used general-purpose monitors that are currently most popularly used are configured to display two-dimensional images in a two-dimensional manner and are not capable of stereoscopically displaying two-dimensional images. If a viewer wishes to have a stereoscopic view on a general-purpose monitor, the apparatus that outputs images to the general-purpose monitor needs to cause two-eye disparity images capable of providing the viewer with a stereoscopic view to be displayed side by side, by using a parallel view method or a cross-eyed view method. Alternatively, the apparatus that outputs images to a general-purpose monitor needs to cause images capable of providing the viewer with a stereoscopic view to be displayed by, for example, using an anaglyphic method that requires glasses having red cellophane attached to the left-eye part thereof and blue cellophane attached to the right-eye part thereof.

As for an example of the stereoscopic display monitor, a monitor is known that is capable of providing a stereoscopic view of two-eye disparity images (may be called “binocular disparity images”), with the use of an exclusive-use device such as stereoscopic glasses.

FIGS. 2A and 2B are drawings for explaining an example of a stereoscopic display monitor that realizes a stereoscopic display by using two-eye disparity images. The example shown in FIGS. 2A and 2B illustrates a stereoscopic display monitor that realizes a stereoscopic display by using a shutter method and uses shutter glasses as the stereoscopic glasses worn by the viewer who looks at the monitor. The stereoscopic display monitor is configured to alternately emit two-eye disparity images from the monitor. For example, the monitor shown in FIG. 2A emits images to be viewed by the left eye (hereinafter, “left-eye images”) and images to be viewed by the right eye (hereinafter, “right-eye images”) alternately at 120 Hz. In this situation, as shown in FIG. 2A, the monitor is provided with an infrared ray emitting unit, which controls emissions of infrared rays in synchronization with the timing with which the images are switched.

The infrared rays emitted from the infrared ray emitting unit are received by an infrared ray receiving unit of the shutter glasses shown in FIG. 2A. Each of the left and right frames of the shutter glasses has a shutter attached thereto, so that the shutter glasses are able to alternately switch between a light transmitting state and a light blocking state, for each of the left and the right shutters in synchronization with the timing with which the infrared rays are received by the infrared ray receiving unit. In the following sections, the process to switch between the light transmitting state and the light blocking state of the shutters will be explained.

As shown in FIG. 2B, each of the shutters includes an entering-side polarizing plate and an exiting-side polarizing plate and further includes a liquid crystal layer between the entering-side polarizing plate and the exiting-side polarizing plate. The entering-side polarizing plate and the exiting-side polarizing plate are positioned orthogonal to each other as shown in FIG. 2B. In this situation, as shown in FIG. 2B, while the voltage is not applied (“OFF”), the light that has passed through the entering-side polarizing plate is rotated by 90 degrees due to an action of the liquid crystal layer and transmits through the exiting-side polarizing plate. In other words, the shutter is in the light transmitting state while the voltage is not being applied.

On the contrary, as shown in FIG. 2B, while the voltage is being applied (“ON”), because the polarization rotation action of the liquid crystal molecules in the liquid crystal layer is lost, the light that has passed through the entering-side polarizing plate is blocked by the exiting-side polarizing plate. In other words, the shutter is in the light blocking state while the voltage is being applied.

In this arrangement, for example, the infrared ray emitting unit emits infrared rays during the time period when a left-eye image is being displayed on the monitor. The infrared ray receiving unit applies no voltage to the left-eye shutter and applies a voltage to the right-eye shutter, during the time period when receiving the infrared rays. As a result, as shown in FIG. 2A, the right-eye shutter is in the light blocking state, whereas the left-eye shutter is in the light transmitting state, so that the left-eye image goes into the left eye of the viewer. On the contrary, the infrared ray emitting unit stops emitting infrared rays during the time period when a right-eye image is being displayed on the monitor. The infrared ray receiving unit applies no voltage to the right-eye shutter and applies a voltage to the left-eye shutter, during the time period when receiving no infrared rays. As a result, the left-eye shutter is in the light blocking state, whereas the right-eye shutter is in the light transmitting state, so that the right-eye image goes into the right eye of the viewer. In this manner, the stereoscopic display monitor shown in FIGS. 2A and 2B displays the images capable of providing the viewer with a stereoscopic view, by switching the images displayed by the monitor and the state of the shutters in conjunction with one another. Instead of the shutter method described above, a monitor that uses a polarized-glasses method is also known as a stereoscopic display monitor that is capable of providing a stereoscopic view of two-eye disparity images.

Further, examples of stereoscopic display monitors that were put in practical use in recent years include an apparatus that enables a glass-free viewer to have a stereoscopic view of multiple-eye disparity images such as nine-eye disparity images by using a light beam controller such as a lenticular lens. Such a stereoscopic display monitor is configured to enable the viewer to have a stereoscopic view using a binocular disparity and further enables the viewer to have a stereoscopic view using a motion disparity, by which the viewed pictures also change in accordance with shifting of the viewpoints of the viewer.

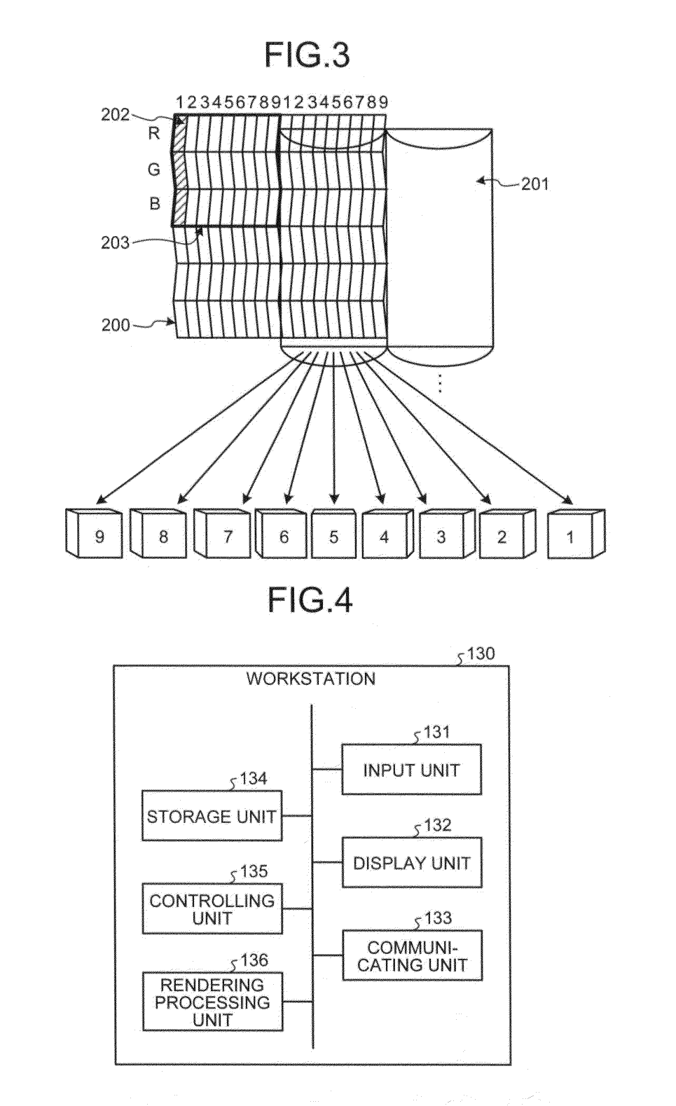

FIG. 3 is a drawing for explaining an example of a stereoscopic display monitor that realizes a stereoscopic display by using nine-eye disparity images. The stereoscopic display monitor shown in FIG. 3 is configured so that a light beam controller is disposed to the front of a flat-shaped display surface 200 such as a liquid crystal panel. For example, the stereoscopic display monitor shown in FIG. 3 is configured so that, as the light beam controller, a vertical lenticular sheet 201 of which the optical openings extend in vertical directions is pasted onto the front of the display surface 200. In the example shown in FIG. 3, the vertical lenticular sheet 201 is pasted in such a manner that the convex parts thereof are positioned to the front. However, the vertical lenticular sheet 201 may be pasted in such a manner that the convex parts thereof face the display surface 200.

As shown in FIG. 3, on the display surface 200, pixels 202 are arranged in a matrix formation, each of the pixels 202 having a length-width ratio of 3:1 and having three sub-pixels for red (R), green (G), and blue (B) arranged in the lengthwise direction. The stereoscopic display monitor shown in FIG. 3 is configured to convert nine-eye disparity images made up of nine images into intermediate images that are arranged in a predetermined format (e.g., in a lattice pattern) and outputs the conversion result to the display surface 200. In other words, the stereoscopic display monitor shown in FIG. 3 outputs nine pixels in mutually the same position in the nine-eye disparity images, while assigning those pixels to nine columns of the pixels 202, respectively. The nine columns of pixels 202 form a unit pixel group 203 that simultaneously displays nine images having mutually-different viewpoint positions.

The nine-eye disparity images that are simultaneously output as the unit pixel group 203 from the display surface 200 are emitted as parallel beams by, for example, a Light Emitting Diode (LED) backlight and are further emitted in multiple directions by the vertical lenticular sheet 201. Because the light beams of the pixels in the nine-eye disparity images are emitted in the multiple directions, the light beams entering the right eye and the left eye of the viewer change in conjunction with the position of the viewer (the viewpoint position). In other words, depending on the angle at which the viewer views the image, the disparity angles of the disparity image entering the right eye and the disparity image entering the left eye vary. As a result, the viewer is able to have a stereoscopic view of the target of an image-taking process (hereinafter, “image-taking target”) at each of the nine positions shown in FIG. 3, for example. Further, for example, the viewer is able to have a stereoscopic view at the position “5” shown in FIG. 3 while facing the image-taking target straight on and is able to have a stereoscopic view at each of the positions other than the position “5” shown in FIG. 3 while the direction of the image-taking target is varied. The stereoscopic display monitor shown in FIG. 3 is merely an example. The stereoscopic display monitor that displays nine-eye disparity images may be configured with liquid crystal stripes arranged in a widthwise direction such as “R, R, R, . . . G, G, G, . . . B, B, B, . . . ” as shown in FIG. 3 or may be configured with liquid crystal stripes arranged in a lengthwise direction such as “R, G, B, R, G, B, . . . ”. Further, the stereoscopic display monitor shown in FIG. 3 may be realized with a lengthwise lens method where the lenticular sheet is positioned vertically as shown in FIG. 3 or may be realized with a diagonal lens method where the lenticular sheet is positioned diagonally.

The exemplary configuration of the image processing system 1 according to the first embodiment has thus been explained briefly. The application of the image processing system 1 described above is not limited to the situation where the PACS is introduced. For example, it is possible to apply the image processing system 1 similarly to a situation where an electronic medical record system that manages electronic medical records to which medical images are attached is introduced. In that situation, the image storing apparatus 120 is configured as a database storing therein the electronic medical records. Further, it is acceptable to apply the image processing system 1 similarly to a situation where, for example, a Hospital Information System (HIS), or a Radiology Information System (RIS) is introduced. Further, the image processing system 1 is not limited to the exemplary configuration described above. The functions of the apparatuses and the distribution of the functions among the apparatuses may be changed as necessary according to modes of operation thereof.

Next, an exemplary configuration of the workstation according to the first embodiment will be explained, with reference to FIG. 4. FIG. 4 is a drawing for explaining the exemplary configuration of the workstation according to the first embodiment. In the following sections, the term “a group of disparity images” refers to a group of images that realize a stereoscopic view and are generated by performing a volume rendering process on volume data. Further, the term “disparity image” refers to each of the individual images constituting “a group of disparity images”. In other words, “a group of disparity images” is made up of a plurality of “disparity images” having mutually-different viewpoint positions.

The workstation 130 according to the first embodiment is a high-performance computer suitable for performing image processing processes and the like. As shown in FIG. 4, the workstation 130 includes an input unit 131, a display unit 132, a communicating unit 133, a storage unit 134, a controlling unit 135, and a rendering processing unit 136. The explanation below is based on an example in which the workstation 130 is a high-performance computer suitable for performing image processing processes and the like; however, the exemplary embodiments are not limited to this example. The workstation 130 may be an arbitrary information processing apparatus. For example, the workstation 130 may be an arbitrary personal computer.

The input unit 131 is configured with a mouse, a keyboard, a trackball and/or the like and receives inputs of various types of operations performed on the workstation 130 from the operator. More specifically, the input unit 131 according to the first embodiment receives an input of information used for obtaining the volume data serving as a target of a rendering process, from the image storing apparatus 120. For example, the input unit 131 receives an input of a subject ID, a medical examination ID, an apparatus ID, a series ID, and/or the like. Further, the input unit 131 according to the first embodiment receives an input of conditions related to the rendering process (hereinafter, “rendering conditions”).

The display unit 132 is a liquid crystal panel or the like that serves as the stereoscopic display monitor and is configured to display various types of information. More specifically, the display unit 132 according to the first embodiment displays a Graphical User Interface (GUI) used for receiving various types of operations from the operator, the group of disparity images, and the like. The communicating unit 133 is a Network Interface Card (NIC) or the like and is configured to communicate with other apparatuses.

The storage unit 134 is a hard disk, a semiconductor memory element, or the like and is configured to store therein various types of information. More specifically, the storage unit 134 according to the first embodiment stores therein the volume data obtained from the image storing apparatus 120 via the communicating unit 133. Further, the storage unit 134 according to the first embodiment stores therein volume data on which a rendering process is being performed, a group of disparity images generated by performing a rendering process, and the like.

The controlling unit 135 is an electronic circuit such as a Central Processing Unit (CPU), a Micro Processing Unit (MPU), or a Graphics Processing Unit (GPU), or an integrated circuit such as an Application Specific Integrated Circuit (ASIC) or a Field Programmable Gate Array (FPGA) and is configured to exercise overall control of the workstation 130.

For example, the controlling unit 135 according to the first embodiment controls the display of the GUI or the display of the group of disparity images on the display unit 132. As another example, the controlling unit 135 controls the transmissions and the receptions of the volume data and the group of disparity images that are transmitted to and received from the image storing apparatus 120 via the communicating unit 133. As yet another example, the controlling unit 135 controls the rendering process performed by the rendering processing unit 136. As yet another example, the controlling unit 135 controls the reading of the volume data from the storage unit 134 and the storing of the group of disparity images into the storage unit 134.

Under the control of the controlling unit 135, the rendering processing unit 136 generates the group of disparity images by performing various types of rendering processes on the volume data obtained from the image storing apparatus 120. More specifically, the rendering processing unit 136 according to the first embodiment reads the volume data from the storage unit 134 and first performs a pre-processing process on the read volume data. Subsequently, the rendering processing unit 136 generates the group of disparity images by performing a volume rendering process on the pre-processed volume data. After that, the rendering processing unit 136 generates a two-dimensional image in which various types of information (a scale mark, the subject's name, tested items, and the like) are rendered and superimposes the generated two-dimensional image onto each member of the group of disparity images so as to generate output-purpose two-dimensional images. Further, the rendering processing unit 136 stores the generated group of disparity images and the output-purpose two-dimensional images into the storage unit 134. In the first embodiment, the “rendering process” refers to the entirety of the image processing performed on the volume data. The “volume rendering process” refers to a part of the rendering process and is a process to generate the two-dimensional images reflecting three-dimensional information. Medical images generated by performing a rendering process may correspond to, for example, disparity images.

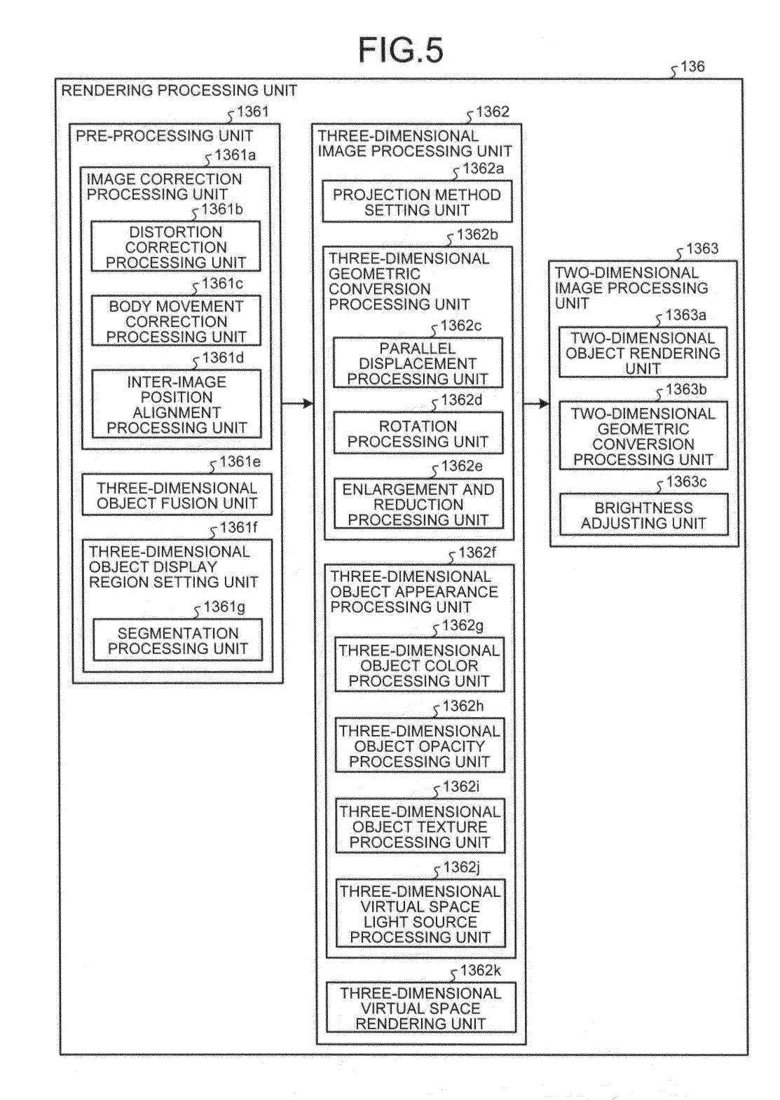

FIG. 5 is a drawing for explaining an exemplary configuration of the rendering processing unit shown in FIG. 4. As shown in FIG. 5, the rendering processing unit 136 includes a pre-processing unit 1361, a three-dimensional image processing unit 1362, and a two-dimensional image processing unit 1363. The pre-processing unit 1361 performs the pre-processing process on the volume data. The three-dimensional image processing unit 1362 generates the group of disparity images from the pre-processed volume data. The two-dimensional image processing unit 1363 generates the output-purpose two-dimensional images obtained by superimposing the various types of information on the group of disparity images. These units will be explained one by one below.

The pre-processing unit 1361 is a processing unit that performs various types of pre-processing processes before performing the rendering process on the volume data and includes an image correction processing unit 1361a, a three-dimensional object fusion unit 1361e, and a three-dimensional object display region setting unit 1361f.

The image correction processing unit 1361a is a processing unit that performs an image correction process, when two types of volume data are processed as one piece of volume data and includes, as shown in FIG. 5, a distortion correction processing unit 1361b, a body movement correction processing unit 1361c, and an inter-image position alignment processing unit 1361d. For example, when volume data of a PET image and volume data of an X-ray CT image that are generated by a PET-CT apparatus are to be processed as one piece of volume data, the image correction processing unit 1361a performs an image correction process. As another example, when volume data of a T1-weighted image and volume data of a T2-weighted image that are generated by an MRI apparatus are to be processed as one piece of volume data, the image correction processing unit 1361a performs an image correction process.

Further, for each piece of volume data, the distortion correction processing unit 1361b corrects a distortion in the data caused by acquiring conditions used during a data acquiring process performed by the medical image diagnosis apparatus 110. Further, the body movement correction processing unit 1361c corrects movements caused by body movements of the subject that occurred during a data acquisition period used for generating each piece of volume data. The inter-image position alignment processing unit 1361d performs a position alignment (registration) process that uses, for example, a cross-correlation method, on two pieces of volume data on which the correction processes have been performed by the distortion correction processing unit 1361b and the body movement correction processing unit 1361c.

The three-dimensional object fusion unit 1361e fuses together the plurality of pieces of volume data on which the position alignment process has been performed by the inter-image position alignment processing unit 1361d. The processes performed by the image correction processing unit 1361a and the three-dimensional object fusion unit 1361e are omitted if the rendering process is performed on a single piece of volume data.

The three-dimensional object display region setting unit 1361f is a processing unit that sets a display region corresponding to a display target organ specified by the operator and includes a segmentation processing unit 1361g. The segmentation processing unit 1361g is a processing unit that extracts an organ specified by the operator such as the heart, a lung, or a blood vessel, by using, for example, a region growing method based on pixel values (voxel values) of the volume data.

If no display target organ was specified by the operator, the segmentation processing unit 1361g does not perform the segmentation process. As another example, if a plurality of display target organs are specified by the operator, the segmentation processing unit 1361g extracts the corresponding plurality of organs. The process performed by the segmentation processing unit 1361g may be performed again, in response to a fine-adjustment request from the operator who has observed the rendering images.

The three-dimensional image processing unit 1362 performs the volume rendering process on the pre-processed volume data processed by the pre-processing unit 1361. As processing units that perform the volume rendering process, the three-dimensional image processing unit 1362 includes a projection method setting unit 1362a, a three-dimensional geometric conversion processing unit 1362b, a three-dimensional object appearance processing unit 1362f, and a three-dimensional virtual space rendering unit 1362k.

The projection method setting unit 1362a determines a projection method used for generating the group of disparity images. For example, the projection method setting unit 1362a determines whether the volume rendering process is to be performed by using a parallel projection method or is to be performed by using a perspective projection method.

The three-dimensional geometric conversion processing unit 1362b is a processing unit that determines information used for three-dimensionally and geometrically converting the volume data on which the volume rendering process is performed and includes a parallel displacement processing unit 1362c, a rotation processing unit 1362d, and an enlargement and reduction processing unit 1362e. The parallel displacement processing unit 1362c is a processing unit that, when the viewpoint positions used in the volume rendering process are moved in a parallel displacement, determines a displacement amount by which the volume data should be moved in a parallel displacement. The rotation processing unit 1362d is a processing unit that, when the viewpoint positions used in the volume rendering process are moved in a rotational shift, determines a shift amount by which the volume data should be moved in a rotational shift. The enlargement and reduction processing unit 1362e is a processing unit that, when an enlargement or a reduction of the group of disparity images is requested, determines an enlargement ratio or a reduction ratio of the volume data.

The three-dimensional object appearance processing unit 1362f includes a three-dimensional object color processing unit 1362g, a three-dimensional object opacity processing unit 1362h, a three-dimensional object texture processing unit 1362i, and a three-dimensional virtual space light source processing unit 1362j. By using these processing units, the three-dimensional object appearance processing unit 1362f performs a process to determine a display state of the group of disparity images to be displayed, according to, for example, a request from the operator.

The three-dimensional object color processing unit 1362g is a processing unit that determines the colors applied to the regions resulting from the segmentation process within the volume data. The three-dimensional object opacity processing unit 1362h is a processing unit that determines opacity of each of the voxels constituting the regions resulting from the segmentation process within the volume data. A region positioned behind a region of which the opacity is set to “100%” in the volume data will not be rendered in the group of disparity images. As another example, a region of which the opacity is set to “0%” in the volume data will not be rendered in the group of disparity images.

The three-dimensional object texture processing unit 1362i is a processing unit that adjusts the texture that is used when each of the regions is rendered, by determining the texture of each of the regions resulting from the segmentation process within the volume data. The three-dimensional virtual space light source processing unit 1362j is a processing unit that determines a position of a virtual light source to be placed in a three-dimensional virtual space and a type of the virtual light source, when the volume rendering process is performed on the volume data. Examples of types of the virtual light source include a light source that radiates parallel light beams from an infinite distance and a light source that radiates radial light beams from a viewpoint.

The three-dimensional virtual space rendering unit 1362k generates the group of disparity images by performing the volume rendering process on the volume data. When performing the volume rendering process, the three-dimensional virtual space rendering unit 1362k uses, as necessary, the various types of information determined by the projection method setting unit 1362a, the three-dimensional geometric conversion processing unit 1362b, and the three-dimensional object appearance processing unit 1362f.

In this situation, the volume rendering process performed by the three-dimensional virtual space rendering unit 1362k is performed according to the rendering conditions. An example of the rendering conditions is the “parallel projection method” or the “perspective projection method”. Another example of the rendering conditions is “a reference viewpoint position, the disparity angle, and the disparity number”. Other examples of the rendering conditions include “a parallel displacement of the viewpoint position”, “a rotational shift of the viewpoint position”, “an enlargement of the group of disparity images”, and “a reduction of the group of disparity images”. Further examples of the rendering conditions include “the colors to be applied”, “the opacity”, “the texture”, “the position of the virtual light source”, and “the type of the virtual light source”. These rendering conditions may be received from the operator via the input unit 131 or may be specified in initial settings. In either situation, the three-dimensional virtual space rendering unit 1362k receives the rendering conditions from the controlling unit 135 and performs the volume rendering process on the volume data according to the received rendering conditions. Further, in that situation, because the projection method setting unit 1362a, the three-dimensional geometric conversion processing unit 1362b, and the three-dimensional object appearance processing unit 1362f described above determine the required various types of information according to the rendering conditions, the three-dimensional virtual space rendering unit 1362k generates the group of disparity images by using those various types of information that were determined.

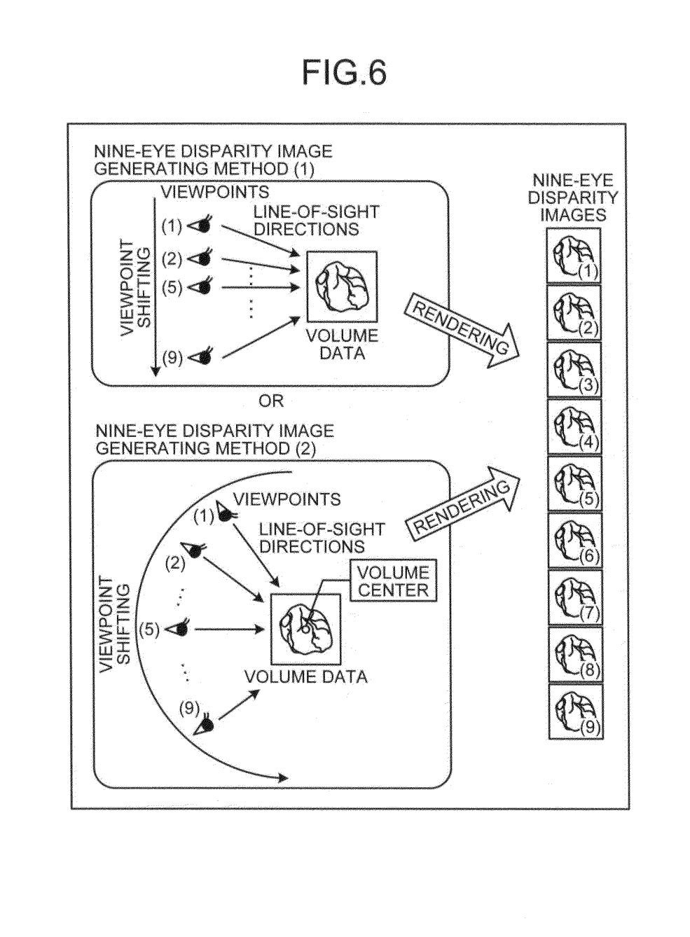

FIG. 6 is a drawing for explaining an example of the volume rendering process according to the first embodiment. For example, let us discuss a situation in which, as shown in “nine-eye disparity image generating method (1)” in FIG. 6, the three-dimensional virtual space rendering unit 1362k receives, as rendering conditions, the parallel projection method and further receives viewpoint position (5) used as a reference point and a disparity angle “1 degree”. In that situation, the three-dimensional virtual space rendering unit 1362k uses the parallel projection method and generates nine disparity images in which the disparity angles (the angles between the line-of-sight directions) are different by 1 degree each, by moving the viewpoint position to positions (1) to (9) in the manner of a parallel displacement, so that the disparity angles are mutually different by “1 degree”. When implementing the parallel projection method, the three-dimensional virtual space rendering unit 1362k sets a light source that radiates parallel light beams from an infinite distance along the line-of-sight directions.

As another example, let us discuss a situation in which, as shown in “nine-eye disparity image generating method (2)” in FIG. 6, the three-dimensional virtual space rendering unit 1362k receives, as rendering conditions, the perspective projection method and further receives viewpoint position (5) used as a reference point and a disparity angle “1 degree”. In that situation, the three-dimensional virtual space rendering unit 1362k uses the perspective projection method and generates nine disparity images in which the disparity angles are different by 1 degree each, by moving the viewpoint position to positions (1) to (9) in the manner of a rotational shift, so that the disparity angles are mutually different by “1 degree” while being centered on the center (the gravity point) of the volume data. When implementing the perspective projection method, the three-dimensional virtual space rendering unit 1362k sets, at each of the viewpoints, a point light source or an area light source that three-dimensionally and radially radiates light being centered on the line-of-sight direction. Alternatively, when the perspective projection method is implemented, it is acceptable to move viewpoints (1) to (9) in the manner of a parallel displacement, depending on rendering conditions being used.

As yet another example, the three-dimensional virtual space rendering unit 1362k may perform a volume rendering process while using the parallel projection method and the perspective projection method together, by setting a light source that two-dimensionally and radially radiates light being centered on the line-of-sight direction with respect to the lengthwise direction of the volume rendering image to be displayed and that radiates parallel light beams from an infinite distance along the line-of-sight direction with respect to the widthwise direction of the volume rendering image to be displayed.

The nine disparity images generated in this manner constitute the group of disparity images. In the first embodiment, for example, the nine disparity images are converted, by the controlling unit 135, into the intermediate images that are arranged in the predetermined format (e.g., in a lattice pattern), and the conversion result is output to the display unit 132 serving as the stereoscopic display monitor. As a result, the operator of the workstation 130 is able to perform the operation to generate a group of disparity images, while viewing the medical images that are capable of providing a stereoscopic view and are being displayed on the stereoscopic display monitor.

In the example illustrated in FIG. 6, the situation is explained where the projection method, the reference viewpoint position, and the disparity angle are received as the rendering conditions; however, in other situations where other conditions are received as the rendering conditions, the three-dimensional virtual space rendering unit 1362k similarly generates a group of disparity images, while ensuring that each of the rendering conditions is reflected.

Further, the three-dimensional virtual space rendering unit 1362k has a function of, not only performing the volume rendering process, but also reconstructing a Multi Planar Reconstruction (MPR) image from the volume data by implementing an MPR method. In addition, the three-dimensional virtual space rendering unit 1362k also has a function of performing a “curved MPR” and a function of performing an “intensity projection”.

After that, each member of the group of disparity images generated by the three-dimensional image processing unit 1362 from the volume data is used as an underlay. By superimposing an overlay in which the various types of information (a scale mark, the subject's name, tested items, and the like) are rendered onto the underlay images, the output-purpose two-dimensional images are obtained. The two-dimensional image processing unit 1363 is a processing unit that generates the output-purpose two-dimensional images by performing an image processing process on the overlay and underlay images. As shown in FIG. 5, the two-dimensional image processing unit 1363 includes a two-dimensional object rendering unit 1363a, a two-dimensional geometric conversion processing unit 1363b, and a brightness adjusting unit 1363c. For example, to reduce the load required by the generating process of the output-purpose two-dimensional images, the two-dimensional image processing unit 1363 generates nine output-purpose two-dimensional images by superimposing one overlay onto each of the nine disparity images (the underlay images). Hereinafter, each of the underlay images onto which the overlay is superimposed may simply be referred to as a “disparity image”.

The two-dimensional object rendering unit 1363a is a processing unit that renders the various types of information rendered in the overlay. The two-dimensional geometric conversion processing unit 1363b is a processing unit that performs a parallel displacement process or a rotational shift process on the positions of the various types of information rendered in the overlay and applies an enlargement process or a reduction process on the various types of information rendered in the overlay.

The brightness adjusting unit 1363c is a processing unit that performs a brightness conversion process and is a processing unit that adjusts brightness levels of the overlay and underlay images, according to parameters used for the image processing process such as the gradation of the stereoscopic display monitor at an output destination, a Window Width (WW), and a Window Level (WL).

The controlling unit 135 temporarily stores the output-purpose two-dimensional images generated in this manner into the storage unit 134, for example, before transmitting the output-purpose two-dimensional images to the image storing apparatus 120 via the communicating unit 133. Further, for example, the terminal apparatus 140 obtains the output-purpose two-dimensional images from the image storing apparatus 120 and converts the obtained images into the intermediate images arranged in the predetermined format (e.g., in a lattice pattern), before having the images displayed on the stereoscopic display monitor. Alternatively, for example, the controlling unit 135 temporarily stores the output-purpose two-dimensional images into the storage unit 134, before transmitting, via the communicating unit 133, the output-purpose two-dimensional images to the image storing apparatus 120 and also to the terminal apparatus 140. Further, the terminal apparatus 140 converts the output-purpose two-dimensional images received from the workstation 130 into the intermediate images arranged in the predetermined format (e.g., in a lattice pattern), before having the images displayed on the stereoscopic display monitor. As a result, a medical doctor or a laboratory technician who uses the terminal apparatus 140 is able to view the medical images that are capable of providing a stereoscopic view, while the various types of information (the scale mark, the subject's name, the tested items, and the like) are rendered therein.

As explained above, the stereoscopic display monitor described above presents the stereoscopic image capable of providing the viewer with a stereoscopic view, by displaying the group of disparity images. For example, by viewing the stereoscopic image before performing an incision operation (craniotomy [head], thoracotomy [chest], laparotomy [abdomen], or the like), the viewer (e.g., a medical doctor) is able to recognize a three-dimensional positional relationship among various types of organs such as blood vessels, the brain, the heart, the lungs, and the like. However, various types of organs of a subject are surrounded by bones (e.g., the skull, the ribs, etc.) and muscles and are therefore, so to speak, enclosed inside the human body. For this reason, when a craniotomy operation is performed, the brain may slightly expand to the outside of the body and arise from the part where the craniotomy incision was made. Similarly, when a thoracotomy or laparotomy operation is performed, organs such as the lungs, the heart, the intestines, the liver, and the like may slightly expand to the outside of the body. For this reason, a stereoscopic image generated by taking images of the subject prior to the surgical operation does not necessarily reflect the state of the inside of the subject during the surgical operation (e.g., after a craniotomy, thoracotomy, or laparotomy operation is performed). As a result, it is difficult for the medical doctor or the like to accurately recognize, prior to a surgical operation, the three-dimensional positional relationship among the various types of organs.

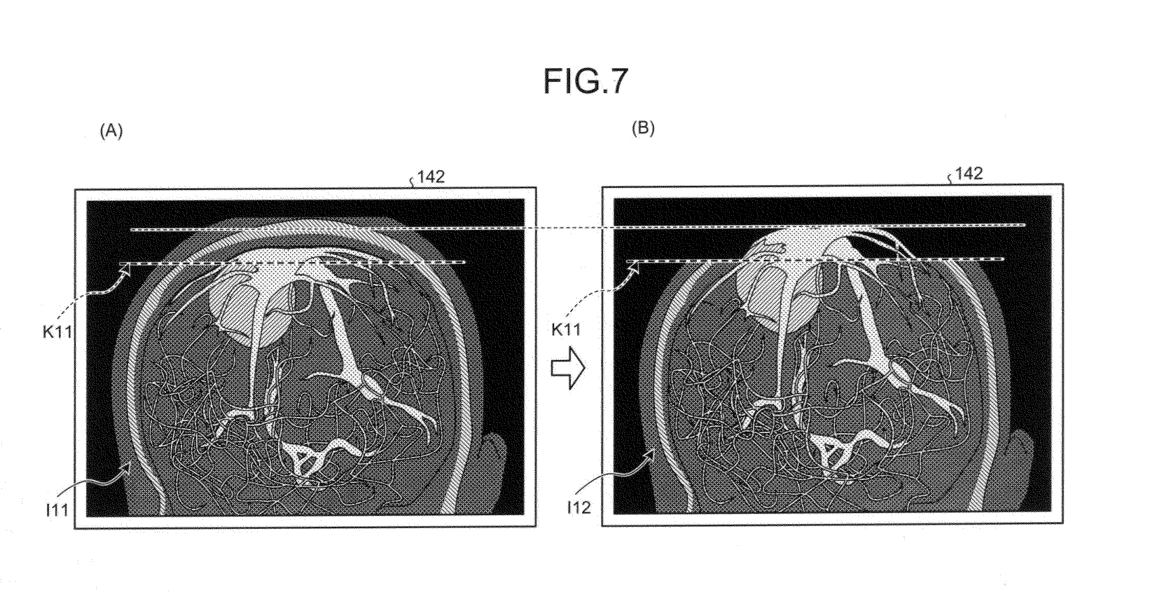

To cope with this situation, the first embodiment makes it possible to display a stereoscopic image showing the state of the inside of the subject during a surgical operation, by estimating the state of the inside of the subject during a surgical operation (after a craniotomy, thoracotomy, or laparotomy operation is performed). This aspect will be briefly explained, with reference to FIG. 7. FIG. 7 is a drawing for explaining an example of a process performed by the image processing system according to the first embodiment. In the first embodiment, an example will be explained in which the workstation 130 generates a group of disparity images by estimating a state in which the inside of the subject will be after a craniotomy operation is performed, whereas the terminal apparatus 140 displays the group of disparity images generated by the workstation 130.

As shown in the example in FIG. 7(A), the terminal apparatus 140 according to the first embodiment includes a stereoscopic display monitor 142 and displays the group of disparity images generated by the workstation 130 on the stereoscopic display monitor 142. In the present example, the terminal apparatus 140 displays the group of disparity images showing the head of the subject on the stereoscopic display monitor 142. As a result, the viewer of the terminal apparatus 140 is able to stereoscopically view a stereoscopic image I11 showing the head of the subject. Further, from the viewer, the terminal apparatus 140 receives a designation of an incision region, which is a region where an incision is to be made within the stereoscopic image I11. In the present example, let us assume that the terminal apparatus 140 receives an incision region K11 shown in FIG. 7(A). In that situation, the terminal apparatus 140 transmits the incision region K11 to the workstation 130.

When having received the incision region K11 from the terminal apparatus 140, the workstation 130 estimates a state in which the inside of the head will be after a craniotomy operation is performed. More specifically, the workstation 130 estimates positional changes of the brain, the blood vessels, and the like on the inside of the head that will occur when the craniotomy operation is performed at the craniotomy incision site K11. Further, based on the result of the estimation, the workstation 130 generates volume data reflecting the state after the positional changes of the brain, the blood vessels, and the like are made and further generates a new group of disparity images by performing a rendering process on the generated volume data. After that, the workstation 130 transmits the newly-generated group of disparity images to the terminal apparatus 140.

By displaying the group of disparity images received from the workstation 130 on the stereoscopic display monitor 142, the terminal apparatus 140 displays a stereoscopic image I12 showing the state of the head of the subject after the craniotomy operation is performed, as shown in the example in FIG. 7(B). As a result, the viewer (e.g., a medical doctor) is able to have a stereoscopic view of the state of the inside of the head after the craniotomy operation is performed. Consequently, before performing the surgical operation, the viewer is able to recognize the positional relationship among the brain, the blood vessels, and the like of which the positions have changed due to the craniotomy operation.

Next, the workstation 130 and the terminal apparatus 140 according to the first embodiment configured as described above will be explained in detail. In the first embodiment, an example will be explained in which the medical image diagnosis apparatus 110 is an X-ray CT apparatus; however, the medical image diagnosis apparatus 110 may be an MRI apparatus or an ultrasound diagnosis apparatus. The CT values mentioned in the following explanation may be the strength of an MR signal kept in correspondence with each pulse sequence or may be reflected-wave data of ultrasound waves.

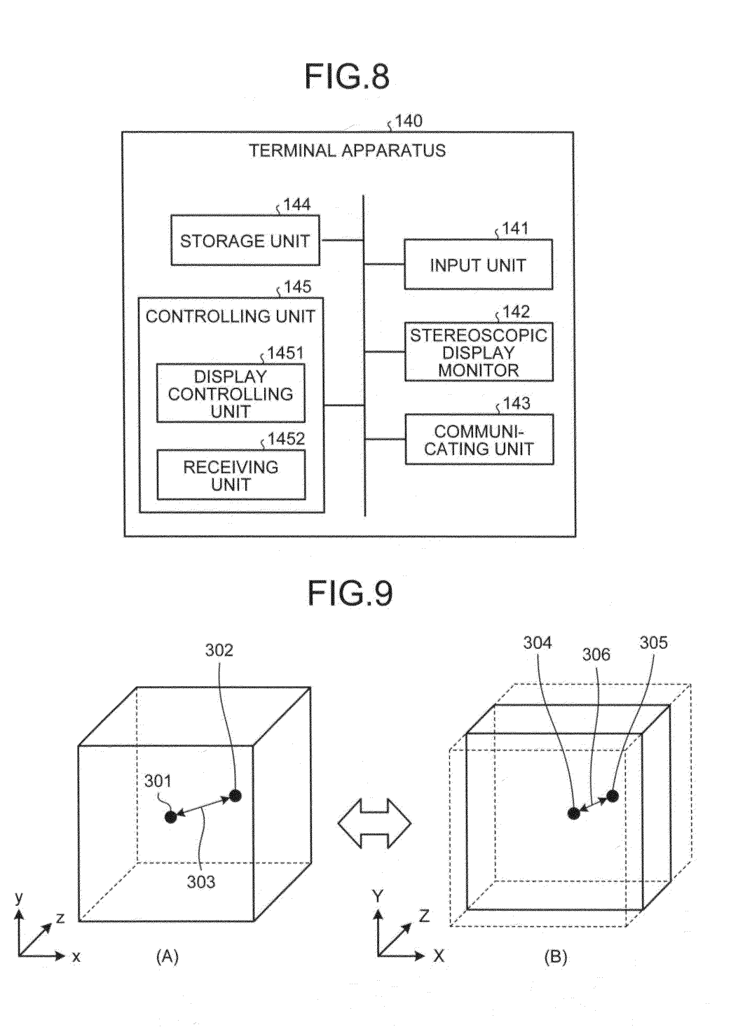

First, the terminal apparatus 140 according to the first embodiment will be explained with reference to FIG. 8. FIG. 8 is a drawing for explaining the terminal apparatus 140 according to the first embodiment. As shown in FIG. 8, the terminal apparatus 140 according to the first embodiment includes an input unit 141, the stereoscopic display monitor 142, a communicating unit 143, a storage unit 144, and a controlling unit 145.

The input unit 141 is a pointing device such as a mouse or a trackball and/or an information input device such as a keyboard and is configured to receive inputs of various types of operations performed on the terminal apparatus 140 from the operator. For example, the input unit 141 receives, as a stereoscopic view request, inputs of a subject ID, a medical examination ID, an apparatus ID, a series ID, and/or the like used for specifying the volume data of which the operator desires to have a stereoscopic view. Further, while the stereoscopic image is being displayed on the stereoscopic display monitor 142, the input unit 141 according to the first embodiment receives a setting of an incision region, which is a region where an incision (e.g., craniotomy, thoracotomy, laparotomy, or the like) is to be made.

The stereoscopic display monitor 142 is a liquid crystal panel or the like and is configured to display various types of information. More specifically, the stereoscopic display monitor 142 according to the first embodiment displays a Graphical User Interface (GUI) used for receiving various types of operations from the operator, the group of disparity images, and the like. For example, the stereoscopic display monitor 142 may be the stereoscopic display monitor explained with reference to FIGS. 2A and 2B (hereinafter, a “two-eye disparity monitor”) or may be the stereoscopic display monitor explained with reference to FIG. 6 (hereinafter, a “nine-eye disparity monitor”). In the following sections, an example in which the stereoscopic display monitor 142 is a nine-eye disparity monitor will be explained.

The communicating unit 143 is a Network Interface Card (NIC) or the like and is configured to communicate with other apparatuses. More specifically, the communicating unit 143 according to the first embodiment transmits the stereoscopic view request received by the input unit 141 to the workstation 130. Further, the communicating unit 143 according to the first embodiment receives the group of disparity images transmitted by the workstation 130 in response to the stereoscopic view request.

The storage unit 144 is a hard disk, a semiconductor memory element, or the like and is configured to store therein various types of information. More specifically, the storage unit 144 according to the first embodiment stores therein the group of disparity images obtained from the workstation 130 via the communicating unit 143. Further, the storage unit 144 also stores therein the additional information (the disparity number, the resolution, the volume space information, and the like) of the group of disparity images obtained from the workstation 130 via the communicating unit 143.

The controlling unit 145 is an electronic circuit such as a CPU, a MPU, or GPU, or an integrated circuit such as an ASIC or an FPGA and is configured to exercise overall control of the terminal apparatus 140. For example, the controlling unit 145 controls the transmissions and the receptions of the stereoscopic view request and the group of disparity images that are transmitted to and received from the workstation 130 via the communicating unit 143. As another example, the controlling unit 145 controls the storing of the group of disparity images into the storage unit 144 and the reading of the group of disparity images from the storage unit 144.

The controlling unit 145 includes, as shown in FIG. 8, a display controlling unit 1451 and a receiving unit 1452. The display controlling unit 1451 causes the stereoscopic display monitor 142 to display the group of disparity images received from the workstation 130. As a result, the group of disparity images is displayed on the stereoscopic display monitor 142, and the viewer of the stereoscopic display monitor 142 is thus able to view the stereoscopic image capable of providing a stereoscopic view.

The receiving unit 1452 receives the setting of the incision region within the stereoscopic image displayed on the stereoscopic display monitor 142. More specifically, when a certain region within the stereoscopic image is designated as the incision region by using the input unit 141 configured with a pointing device or the like, the receiving unit 1452 according to the first embodiment receives, from the input unit 141, coordinates of the incision region within a three-dimensional space (which hereinafter may be referred to as a “stereoscopic image space”) in which the stereoscopic image is displayed. Further, by using a coordinate conversion formula (explained later), the receiving unit 1452 converts the coordinates of the incision region within the stereoscopic image space into coordinates within a space (which hereinafter may be referred to as a “volume data space”) in which the volume data is to be arranged. Further, the receiving unit 1452 transmits the coordinates of the incision region within the volume data space to the workstation 130.

As explained above, the receiving unit 1452 obtains, from the workstation 130, the volume space information related to the three-dimensional space in which the volume data from which the group of disparity images was generated is to be arranged, as the additional information related to the group of disparity images. The receiving unit 1452 uses the three-dimensional space indicated by the obtained volume space information as the volume data space mentioned above.

In this situation, because the stereoscopic image space and the volume data space use mutually-different coordinate systems, the receiving unit 1452 obtains the coordinates within the volume data space corresponding to the stereoscopic image space, by using the predetermined coordinate conversion formula. In the following sections, a correspondence relationship between the stereoscopic image space and the volume data space will be explained, with reference to FIG. 9. FIG. 9 is a drawing of an example of the correspondence relationship between the stereoscopic image space and the volume data space. FIG. 9(A) illustrates the volume data, whereas FIG. 9(B) illustrates the stereoscopic image displayed by the stereoscopic display monitor 142. Coordinates 301, coordinates 302, and a distance 303 shown in FIG. 9(A) correspond to coordinates 304, coordinates 305, and a distance 306 shown in FIG. 9(B), respectively.

As shown in FIG. 9, the volume data space in which the volume data is arranged and the stereoscopic image space in which the stereoscopic image is displayed use the mutually-different coordinate systems. More specifically, the stereoscopic image shown in FIG. 9(B) has a smaller dimension in the depth direction (the z direction) than the volume data shown in FIG. 9(A). In other words, the component in the depth direction in the volume data shown in FIG. 9(A) is displayed in a compressed manner in the stereoscopic image shown in FIG. 9(B). In that situation, as shown in FIG. 9(B), the distance 306 between the coordinates 304 and the coordinates 305 is shorter than the distance 303 between the coordinates 301 and the coordinates 302 shown in FIG. 9(A) due to the compression.

The correspondence relationship between the stereoscopic image space coordinates and the volume data space coordinates are determined in a one-to-one correspondence with the scale, the disparity angle, the line-of-sight direction (the line-of-sight direction during the rendering process or the line-of-sight direction during the viewing of the stereoscopic image), and the like of the stereoscopic image. For example, it is possible to express the correspondence relationship using a formula shown as “Formula 1” below.

(x1,y1,z1)=F(x2,y2,z2) Formula 1

In Formula 1, “x2”, “y2”, and “z2” are the stereoscopic image space coordinates, whereas “x1”, “y1”, and “z1” are the volume data space coordinates. Further, the function “F” is a function that is determined in a one-to-one correspondence with the scale, the disparity angle, the line-of-sight direction, and the like of the stereoscopic image. In other words, the receiving unit 1452 is able to obtain the correspondence relationship between the stereoscopic image space coordinates and the volume data space coordinates by using Formula 1. The function “F” is generated by the receiving unit 1452 every time the scale, the disparity angle, the line-of-sight direction (the line-of-sight direction during the rendering process or the line-of-sight direction during the viewing of the stereoscopic image), and the like of the stereoscopic image is changed. For example, as the function “F” used for converting a rotation, a parallel displacement, an enlargement, or a reduction, an affine transformation shown under “Formula 2” below can be used.

x1=a*x2+b*y2+c*z3+d

y1=e*x2+f*y2+g*z3+h

z1=i*x2+j*y2+k*z3+l Formula 2

where “a” to “l” are each a conversion coefficient

In the explanation above, the example is used in which the receiving unit 1452 obtains the coordinates within the volume data space based on the function “F”; however, the exemplary embodiments are not limited to this example. For example, another arrangement is acceptable in which the terminal apparatus 140 has a coordinate table keeping the stereoscopic image space coordinates in correspondence with the volume data space coordinates, whereas the receiving unit 1452 obtains a set of volume data space coordinates corresponding to a set of stereoscopic image space coordinates by conducting a search in the coordinate table while using the set of stereoscopic image space coordinates as a search key.

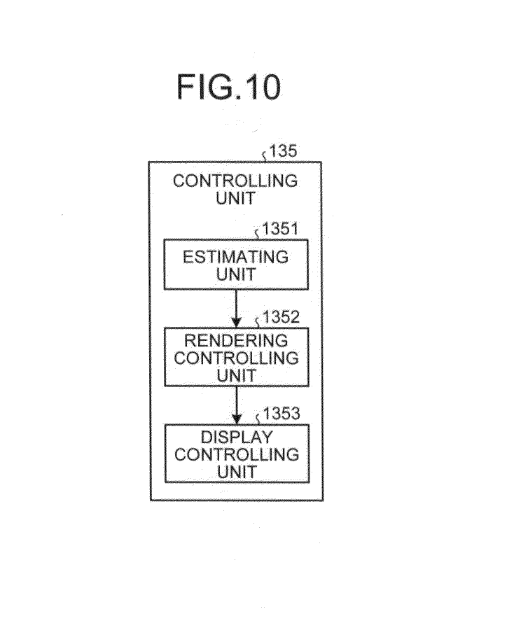

Next, the controlling unit 135 included in the workstation 130 according to the first embodiment will be explained, with reference to FIG. 10. FIG. 10 is a drawing for explaining an exemplary configuration of the controlling unit 135 according to the first embodiment. As illustrated in FIG. 10, the controlling unit 135 included in the workstation 130 includes an estimating unit 1351, a rendering controlling unit 1352, and a display controlling unit 1353.

The estimating unit 1351 estimates the state of the inside of the subject during the surgical operation (e.g., after a craniotomy, thoracotomy, or laparotomy operation is performed). More specifically, when having received the coordinates of the incision region within the volume data space from the receiving unit 1452 included in the terminal apparatus 140, the estimating unit 1351 according to the first embodiment estimates positional changes of the voxels contained in the volume data from which the group of disparity images displayed on the stereoscopic display monitor 142 included in the terminal apparatus 140 was generated.

Even more specifically, the estimating unit 1351 eliminates the voxels representing surface sites (e.g., the skin, skull, muscles, and the like) of the subject from the voxels in the volume data positioned at the coordinates of the incision region received from the receiving unit 1452. For example, the estimating unit 1351 replaces CT values of the voxels representing the surface sites with a CT value representing air. Further, after having eliminated the surface sites, the estimating unit 1351 estimates the positional change of each of the voxels in the volume data, based on various types of parameters “X1” to “X7” shown below, or the like. The “positional change” mentioned here includes a movement vector (a movement direction and a movement amount) of each voxel and an expansion ratio.

X1: the pressure (the internal pressure) applied from the surface sites to the organ or the like
X2: the CT value
X3: the size of the incision region
X4: the distance to the incision region
X5: the CT value of an adjacent voxel
X6: the blood flow velocity, the blood flow volume, and the blood pressure
X7: information about the subject

First, “X1” listed above will be explained. Various types of organs inside the subject are surrounded by surface sites such as bones and muscles that are present at the surface of the subject and receive pressure from those surface sites. For example, prior to a craniotomy operation, the brain is surrounded by the skull and is receiving pressure from the skull. The “X1” listed above denotes the pressure (which hereinafter may be referred to as the “internal pressure”) applied to the inside of the subject. In the example described above, “X1” denotes the pressure applied to the brain due to the presence of the skull. When the surface sites are removed, the various types of organs inside the subject stop receiving the internal pressure from the surface sites and are therefore prone to move in the directions toward the removed surface sites and are also prone to expand. For this reason, when estimating the positional change of each of the voxels, the estimating unit 1351 uses the internal pressure indicated as “X1” above. The internal pressure applied to each of the sites (the voxels) is calculated in advance based on the distance between the site (the voxel) and the surface sites, the hardness of the surface sites, and the like.

Further, “X2” listed above will be explained. The CT value is a value indicating characteristics of an organ and indicates, for example, the hardness of the organ. Generally speaking, the higher the CT value of an organ is, the harder is the organ. In this situation, because harder organs are less prone to move and less prone to expand, levels of CT values can be used as an index of the movement amount and the expansion rate of each of the various types of organs. For this reason, when estimating the positional change of each of the voxels, the estimating unit 1351 uses the CT value indicated as “X2” above.

Next, “X3” listed above will be explained. When the size of the incision region is multiplied by the internal pressure indicated as “X1” above, a sum of the forces applied to the various types of organs inside the subject can be calculated. It is considered that, generally speaking, the larger an incision region is, the larger are the movement amounts and the expansion rates of the various types of organs inside the subject. For this reason, when estimating the positional change of each of the voxels, the estimating unit 1351 uses the size of the incision region indicated as “X3” above.

Next, “X4” listed above will be explained. The shorter the distance from an organ to an incision region is, the larger is the impact of the internal pressure on the organ, which is indicated as “X1” above. On the contrary, the longer the distance from an organ to an incision region is, the smaller is the impact of the internal pressure on the organ, which is indicated as “X1” above. In other words, the movement amount and the expansion rate of an organ when a craniotomy operation or the like is performed will vary depending on the distance to the incision region. For this reason, when estimating the positional change of each of the voxels, the estimating unit 1351 uses the distance to the incision region indicated as “X4” above.

Next, “X5” listed above will be explained. Even if the organ is an organ that is prone to move, if a hard site such as a bone is present in an adjacent site, the organ is less prone to move. For example, if a hard site is present between the site where a craniotomy operation is performed and a movement estimation target organ, the movement estimation target organ is less prone to move and is also less prone to expand. For this reason, when estimating the positional change of each of the voxels, the estimating unit 1351 uses the CT value of an adjacent voxel indicated as “X5” above.

Next, “X6” listed above will be explained. The movement amount and the expansion rate of a blood vessel changes depending on the blood flow velocity (the speed at which the blood flows), the blood flow volume (the amount of the blood flowing), and the blood pressure. For example, when a craniotomy operation is performed, the higher the blood flow velocity, the blood flow volume, and the blood pressure of a blood vessel are, the more prone the blood vessel is to move from the craniotomy incision part toward the exterior. For this reason, when estimating the positional change of a blood vessel among the voxels, the estimating unit 1351 may use the blood flow velocity, the blood flow volume, and the blood pressure indicated as “X6” above.

Next, “X7” listed above will be explained. The movement amount and the expansion rate of each of the organs vary depending on the characteristics of the examined subject (the subject). For example, it is possible to obtain an average value of movement amounts and expansion rates of each of the organs, based on information about the subject such as the age, the gender, the weight, the body fat percentage of the subject. For this reason, the estimating unit 1351 may apply a weight to the movement amount and the expansion rate of each of the voxels by using the information about the subject indicated as “X7” above.

By using a function that uses the various types of parameters “X1” to “X7” explained above as variables thereof, the estimating unit 1351 according to the first embodiment estimates the movement vectors and the expansion rates of the voxels in the volume data.

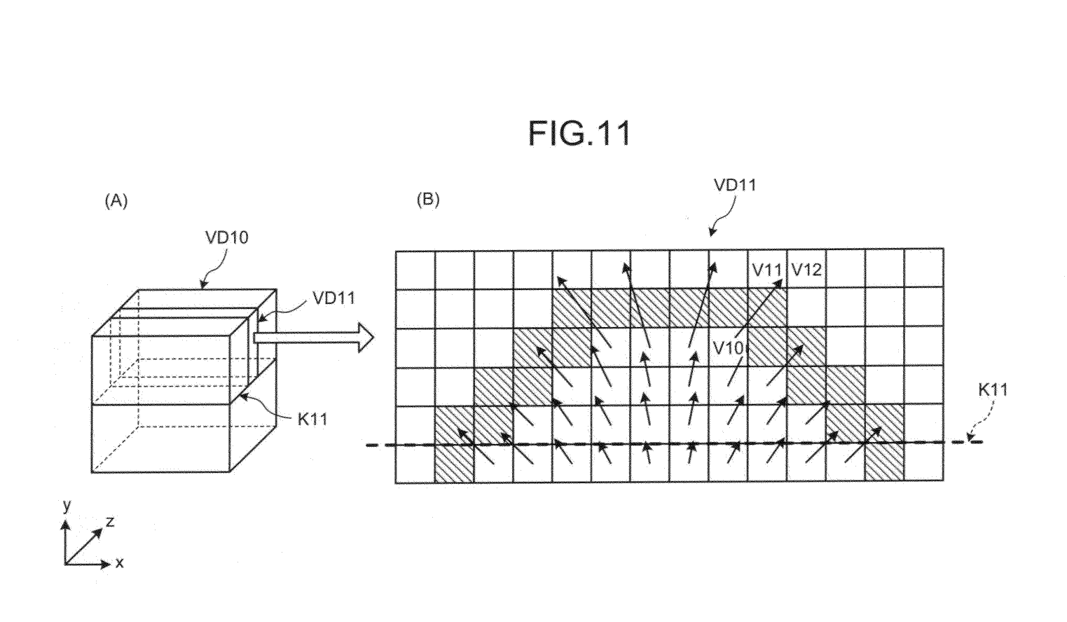

Next, an example of an estimating process performed by the estimating unit 1351 will be explained, with reference to FIG. 11. FIG. 11 is a drawing for explaining the example of the estimating process performed by the estimating unit 1351 according to the first embodiment. In the example shown in FIG. 11, the workstation 130 transmits a group of disparity images generated from volume data VD10 by the rendering processing unit 136, to the terminal apparatus 140. In other words, the terminal apparatus 140 displays the group of disparity images generated from the volume data VD10 on the stereoscopic display monitor 142 and receives an input of an incision region designated in the stereoscopic image displayed by the group of disparity images. In the present example, let us assume that the terminal apparatus 140 has received an incision region K11 shown in FIG. 11. In that situation, the estimating unit 1351 included in the workstation 130 estimates a movement vector and an expansion rate of each of the voxels contained in the volume data VD10. FIG. 11(B) does not illustrate all the voxels, but uses only volume data VD11 out of the volume data VD10 as an example so as to explain the estimating process performed by the estimating unit 1351.

In the example shown in FIG. 11(B), each of the rectangles represents one voxel. Further, the rectangles (the voxels) with hatching represent the skull. In this situation, because the estimating unit 1351 has received the incision region K11, the estimating unit 1351 replaces, from among the voxels with hatching, such voxels that are positioned above the incision region K11 shown in FIG. 11(B) with a CT value of the air or the like. Further, by using a movement estimating function calculated with the parameters “X1” to “X7” explained above or the like, the estimating unit 1351 estimates a movement vector and an expansion rate of each of the voxels. For example, the estimating unit 1351 calculates, for each of the voxels, a movement estimating function by using the internal pressure or the like received from the voxels prior to the replacement with the CT value of the air or the like. In the example shown in FIG. 11(B), the estimating unit 1351 estimates that all the voxels will move in the directions toward the removed surface sites. Also, the estimating unit 1351 estimates that the closer a voxel is positioned to the voxels with hatching (the skull), the larger is the movement amount of the voxel and that the more distant a voxel is positioned from the voxels with hatching (the skull), the smaller is the movement amount of the voxel. In the example shown in FIG. 11, although the voxels seem to have a parallel displacement with respect to the x-y plane, the estimating unit 1351 actually estimates the movement direction of each of the voxels in a three-dimensional manner.

In this manner, the estimating unit 1351 estimates the movement vector of not only each of the voxels contained in the volume data VD11, but also each of the voxels contained in the volume data VD10. Further, although not shown in FIG. 11, the estimating unit 1351 also estimates the expansion rate of each of the voxels.

Returning to the description of FIG. 10, the rendering controlling unit 1352 generates the group of disparity images from the volume data, in collaboration with the rendering processing unit 136. More specifically, based on the result of the estimation by the estimating unit 1351, the rendering controlling unit 1352 according to the first embodiment controls the rendering processing unit 136 so as to generate volume data and to perform a rendering process on the generated volume data. In this situation, the rendering controlling unit 1352 generates a new piece of volume data by causing the movement vectors and the expansion rates of the voxels estimated by the estimating unit to be reflected on the volume data from which the group of disparity images displayed on the stereoscopic display monitor 142 of the terminal apparatus 140 was generated. In the following sections, the volume data on which the estimation result is reflected may be referred to as “virtual volume data”.

Next, an example of a virtual volume data generating process performed by the rendering controlling unit 1352 will be explained with reference to FIG. 11. In the example shown in FIG. 11(B), when a focus is placed on a voxel V10, the estimating unit 1351 estimates that the voxel V10 will move to a position between a voxel V11 and a voxel V12. Also, in the present example, let us assume that the estimating unit 1351 estimates that the expansion rate of the voxel V10 is “two times (200%)”. In that situation, the rendering controlling unit 1352 arranges the voxel V10 to be in a position between the voxel V11 and the voxel V12 and doubles the size of the voxel V10. For example, the rendering controlling unit 1352 arranges the voxel V10 to be in the voxel V11 and the voxel V12. In this manner, based on the result of the estimation by the estimating unit 1351, the rendering controlling unit 1352 generates the virtual volume data by changing the positional arrangements of the voxels.

Returning to the description of FIG. 10, the display controlling unit 1353 transmits the group of disparity images generated by the rendering processing unit 136 to the terminal apparatus 140 so that the group of disparity images is displayed on the stereoscopic display monitor 142. Further, if a new group of disparity images is generated by the rendering processing unit 136 as a result of the control exercised by the rendering controlling unit 1352, the display controlling unit 1353 according to the first embodiment transmits the new group of disparity images to the terminal apparatus 140. As a result, the terminal apparatus 140 displays, as shown in FIG. 7(B) for example, the stereoscopic image I12 or the like showing the state of the inside of the head after the craniotomy operation, on the stereoscopic display monitor 142.

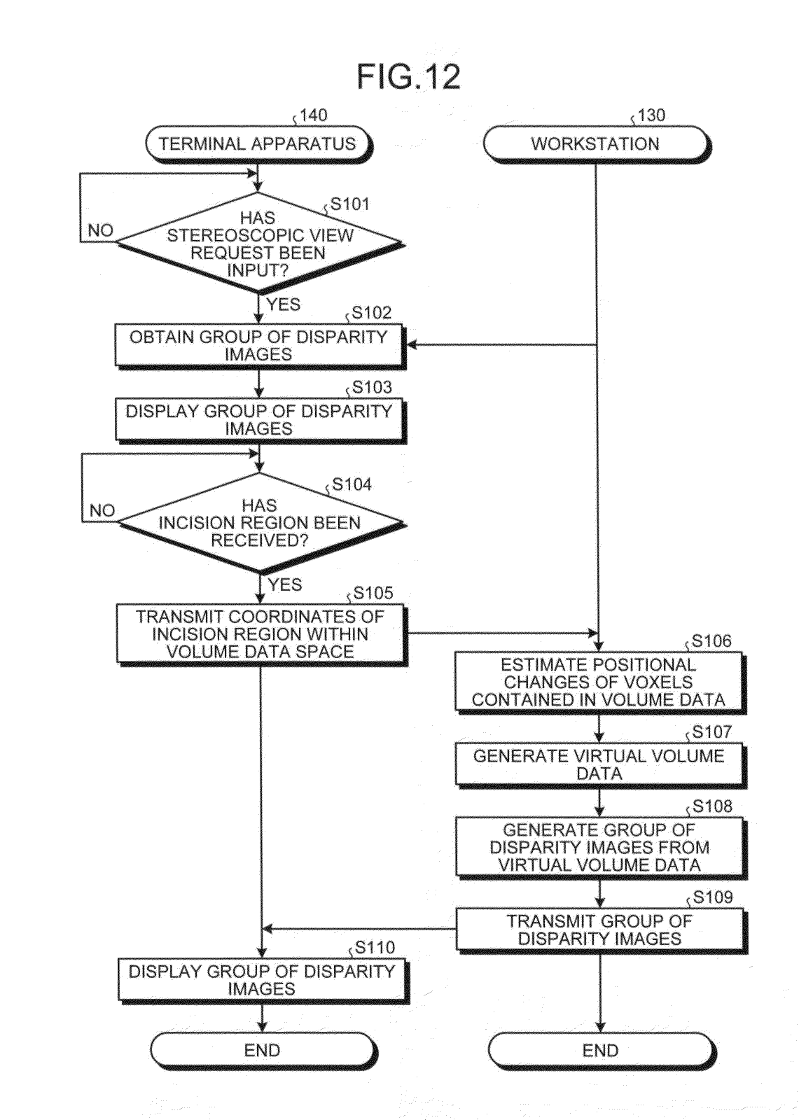

Next, an exemplary flow in a process performed by the workstation 130 and the terminal apparatus 140 according to the first embodiment will be explained, with reference to FIG. 12. FIG. 12 is a sequence chart of the exemplary flow in the process performed by the image processing system according to the first embodiment.

As shown in FIG. 12, the terminal apparatus 140 judges whether a stereoscopic view request has been input from the viewer (step S101). In this situation, if no stereoscopic view request has been input (step S101: No), the terminal apparatus 140 stands by.

On the contrary, if a stereoscopic view request has been input (step S101: Yes), the terminal apparatus 140 obtains a group of disparity images corresponding to the received stereoscopic view request, from the workstation 130 (step S102). After that, the display controlling unit 1451 displays the group of disparity images obtained from the workstation 130, on the stereoscopic display monitor 142 (step S103).

Subsequently, the receiving unit 1452 included in the terminal apparatus 140 judges whether a setting of an incision region within the stereoscopic image displayed on the stereoscopic display monitor 142 has been received (step S104). In this situation, if a setting of an incision region has not been received (step S104: No), the receiving unit 1452 stands by until a setting of an incision region is received.

On the contrary, when a setting of an incision region has been received (step S104: Yes), the receiving unit 1452 obtains the coordinates within the volume data space corresponding to the coordinates of the incision region within the stereoscopic image space by using the function “F” explained above and transmits the obtained coordinates of the incision region within the volume data space to the workstation 130 (step S105).

After that, the estimating unit 1351 included in the workstation 130 eliminates the voxels representing the surface sites of the subject that are positioned at the coordinates of the incision region received from the terminal apparatus 140. The estimating unit 1351 further estimates a positional change (a movement vector and an expansion rate) of each of the voxels in the volume data, based on the various types of parameters “X1” to “X7” explained above or the like (step S106).

Subsequently, the rendering controlling unit 1352 generates virtual volume data by causing the movement vectors and the expansion rates of the voxels estimated by the estimating unit 1351 to be reflected on the volume data (step S107). After that, the rendering controlling unit 1352 generates a group of disparity images by controlling the rendering processing unit 136 so as to perform a rendering process on the virtual volume data (step S108). Further, the display controlling unit 1353 transmits the group of disparity images generated by the rendering processing unit 136 to the terminal apparatus 140 (step S109).

The display controlling unit 1451 included in the terminal apparatus 140 displays the group of disparity images received from the workstation 130, on the stereoscopic display monitor 142 (step S110). The stereoscopic display monitor 142 is thus able to display the stereoscopic image showing the state after the craniotomy operation.

As explained above, according to the first embodiment, it is possible to display the stereoscopic image showing the state of the inside of the subject after the incision operation is performed. As a result, the viewer (e.g., the medical doctor) is able to recognize, prior to the surgical operation, the positional relationship among the various types of organs of which the positions change due to the incision operation (craniotomy, thoracotomy, laparotomy, or the like). Further, for example, by changing the position and/or the size of the incision region, the viewer (e.g., the medical doctor) is able to check the state of a part on the inside of the subject corresponding to each of the incision regions. Thus, the viewer is able to determine, prior to the surgical operation, the position and the size of the incision region that are suitable for the surgical operation.

The first embodiment is not limited to the exemplary embodiments described above and may be implemented in various modes including a number of modification examples described below. In the following sections, modification examples of the first embodiment will be explained.

Automatic Setting of an Incision Region

In the first embodiment described above, the workstation 130 estimates the movement vector and the expansion rate of each of the various types of organs, based on the incision region designated by the viewer; however, another arrangement is acceptable in which the workstation 130 sets incision regions randomly, so that the estimating unit 1351 performs the estimating process described above on each of the incision regions and so that a group of disparity images corresponding to each of the incision regions is transmitted to the terminal apparatus 140. Further, the terminal apparatus 140 may display the plurality of groups of disparity images received from the workstation 130 side by side on the stereoscopic display monitor 142.

Further, another arrangement is also acceptable in which the workstation 130 selects one or more incision regions of which the average values of movement amounts and expansion rates are lower than a predetermined threshold value, from among the incision regions that are set randomly, and transmits one or more groups of disparity images corresponding to the one or more selected incision regions to the terminal apparatus 140. With this arrangement, the viewer (e.g., a medical doctor) is able to find out an incision region that will cause small movement amounts and small expansion rates of the various types of organs when a craniotomy operation or the like is performed.

Estimation of the Movement of Each of the Organs

In the first embodiment described above, the example is explained in which the movement vector and the expansion rate are estimated for each of the voxels. However, another arrangement is acceptable in which the workstation 130 extracts organs such as the heart, the lungs, blood vessels and the like that are contained in the volume data by performing a segmentation process on the volume data and further estimates a movement vector and an expansion rate in units of organs that are extracted. Further, when generating the virtual volume data, the workstation 130 may exercise control so that groups of voxels representing mutually the same organ are positioned adjacent to each other. In other words, when generating the virtual volume data, the workstation 130 may arrange the voxels in such a manner that a stereoscopic image showing an organ does not get divided into sections.

Displaying Images Side by Side

Further, in the first embodiment, the display controlling unit 1451 included in the terminal apparatus 140 may display, side by side, a stereoscopic image showing an actual state of the inside of the subject and a stereoscopic image reflecting the estimation result of the positional changes. For example, the display controlling unit 1451 may display, side by side, the stereoscopic image I11 and the stereoscopic image I12 shown in FIG. 7. As a result, the viewer is able to have a view while comparing the state prior to the surgical operation with the state during the surgical operation. It is possible to realize the side-by-side display as described above by configuring the workstation 130 so as to transmit the group of disparity images for displaying the stereoscopic image I11 and the group of disparity images for displaying the stereoscopic image I12, to the terminal apparatus 140.

Specific Display 1

In the first embodiment described above, another arrangement is acceptable in which the rendering controlling unit 1352 extracts only such a group of voxels that is estimated to move or expand by the estimating unit 1351 and generates a group of disparity images from volume data (which hereinafter may be referred to as “specific volume data”) formed by the extracted group of voxels. In that situation, it means that the stereoscopic display monitor 142 included in the terminal apparatus 140 displays a stereoscopic image showing only the site that was estimated to move or expand. With this arrangement, the viewer is able to easily find the site that is to move or expand.

Specific Display 2

Yet another arrangement is also acceptable in which the rendering controlling unit 1352 superimposes together the group of disparity images generated from the volume data on which the estimation result is not yet reflected and the group of disparity images generated from the specific volume data. In that situation, it means that the stereoscopic display monitor 142 included in the terminal apparatus 140 displays a stereoscopic image in which the state of the inside of the subject prior to the craniotomy operation and the state of the inside of the subject after the craniotomy operation are superimposed together. With this arrangement, the viewer is able to easily find the site that is to move or expand.

Specific Display 3

Yet another arrangement is acceptable in which the rendering controlling unit 1352 applies a color that is different from a normal color to the voxels that are estimated to move or expand by the estimating unit 1351. At that time, the rendering controlling unit 1352 may change the color to be applied depending on the movement amount or the expansion amount. In that situation, it means that the stereoscopic display monitor 142 included in the terminal apparatus 140 displays a stereoscopic image in which the color different from the normal color is applied to only the site that was estimated to move or expand. With this arrangement, the viewer is able to easily find the site that is to move or expand.

### Second Embodiment

In the first embodiment described above, the example is explained in which the positional changes of the various types of organs caused by the craniotomy operation or the like are estimated. In other words, in the first embodiment, the example is explained in which the positional changes of the various types of organs are estimated in the situation where the internal pressure originally applied is released. The various types of organs inside the subject also move when a surgery tool such as an endoscope or a scalpel is inserted therein. In other words, the various types of organs also move when an external force is applied thereto. Thus, in a second embodiment, an example will be explained in which positional changes of various types of organs are estimated in the situation where an external force is applied thereto.

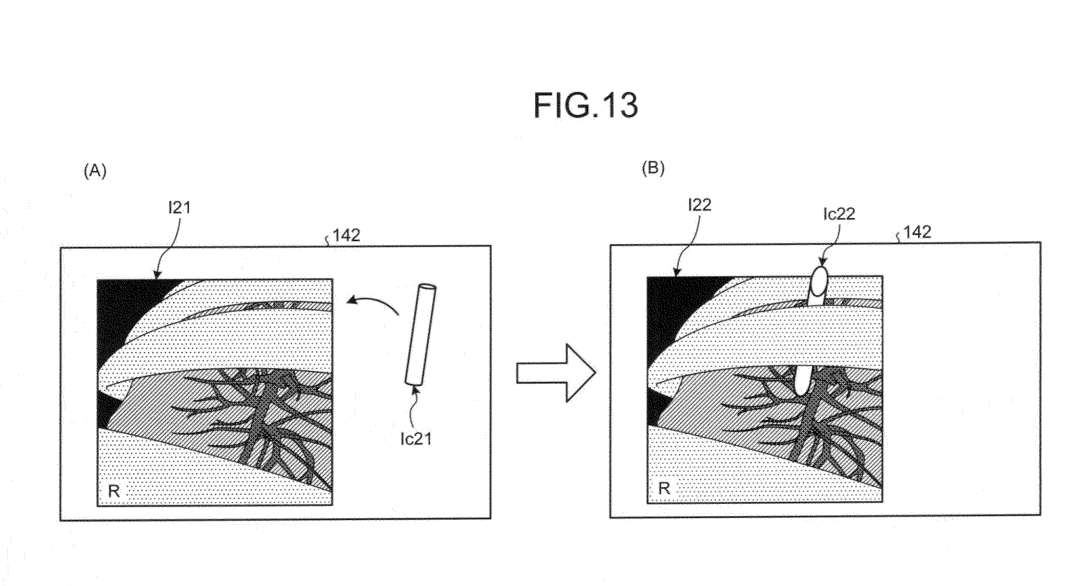

First, a process performed by an image processing system according to the second embodiment will be briefly explained, with reference to FIG. 13. FIG. 13 is a drawing for explaining an example of the process performed by the image processing system according to the second embodiment. FIG. 13 illustrates an example in which a medical device such as an endoscope or a scalpel is inserted in an intercostal space (between ribs). As shown in FIG. 13(A), a terminal apparatus 240 according to the second embodiment displays a stereoscopic image I21 showing the subject and a stereoscopic image Ic21 showing the medical device such as an endoscope or a scalpel on the stereoscopic display monitor 142. The stereoscopic image Ic21 illustrated in FIG. 13 represents a virtual medical device, which is an endoscope in the present example. The terminal apparatus 240 receives, from the viewer, an operation to arrange the stereoscopic image Ic21 into the stereoscopic image space in which the stereoscopic image I21 is being displayed. In the example shown in FIG. 13, the terminal apparatus 240 receives an operation to arrange the stereoscopic image Ic21 into a region representing an intercostal space within the stereoscopic image space in which the stereoscopic image I21 is being displayed. In that situation, the terminal apparatus 240 transmits coordinates within the volume data space corresponding to the position within the stereoscopic image space at which the stereoscopic image Ic21 has been arranged, to a workstation 230.

When having received the position of the stereoscopic image Ic21 from the terminal apparatus 240, the workstation 230 estimates the state of the inside of the subject in the situation where the stereoscopic image Ic21 is inserted. Further, the workstation 230 generates virtual volume data that reflects a result of the estimation and generates a new group of disparity images by performing a rendering process on the generated virtual volume data. After that, the workstation 230 transmits the newly-generated group of disparity images to the terminal apparatus 240.

By displaying the group of disparity images received from the workstation 230 on the stereoscopic display monitor 142, the terminal apparatus 240 displays a stereoscopic image I22 showing the state of the inside of the subject in which the medical device is inserted and a stereoscopic image Ic22 showing the medical device in a state of being inserted in the subject, as shown in the example in FIG. 13(B). With this arrangement, the viewer (e.g., a medical doctor) is able to have a stereoscopic view of the state in which the inside of the subject will be after the medical device is inserted. As a result, the viewer is able to recognize the positional relationship among the various types of sites inside the subject, prior to the surgical operation using the medical device.

Next, the workstation 230 and the terminal apparatus 240 according to the second embodiment will be explained in detail. The workstation 230 corresponds to the workstation 130 shown in FIG. 1, whereas the terminal apparatus 240 corresponds to the terminal apparatus 140 shown in FIG. 1. In the present example, because the configuration of the terminal apparatus 240 according to the second embodiment is the same as the exemplary configuration of the terminal apparatus 140 shown in FIG. 8, the drawing thereof will be omitted. It should be noted, however, that a controlling unit 245 included in the terminal apparatus 240 according to the second embodiment performs a process different from the process performed by the display controlling unit 1451 and the receiving unit 1452 included in the controlling unit 145 shown in FIG. 8. Thus, the controlling unit 245 includes a display controlling unit 2451 instead of the display controlling unit 1451 included in the controlling unit 145 and includes a receiving unit 2452 instead of the receiving unit 1452. Further, because the configuration of a controlling unit 235 included in the workstation 230 according to the second embodiment is the same as the exemplary configuration of the controlling unit 135 shown in FIG. 10, the drawing thereof will be omitted. It should be noted, however, that the controlling unit 235 according to the second embodiment performs a process different from the process performed by the estimating unit 1351 and the rendering controlling unit 1352 included in the controlling unit 135. Thus, the controlling unit 235 includes an estimating unit 2351 instead of the estimating unit 1351 included in the controlling unit 135 and includes a rendering controlling unit 2352 instead of the rendering controlling unit 1352.

In the following sections, the display controlling unit 2451, the receiving unit 2452, the estimating unit 2351, and the rendering controlling unit 2352 will be explained in detail. In the following sections, a stereoscopic image showing the subject may be referred to as a “subject stereoscopic image”, whereas a stereoscopic image showing a medical device may be referred to as a “device stereoscopic image”.

The display controlling unit 2451 included in the terminal apparatus 240 according to the second embodiment causes the stereoscopic display monitor 142 to display a subject stereoscopic image and a device stereoscopic image, as shown in the example in FIG. 13(A). The group of disparity images used for displaying the subject stereoscopic image is generated by the workstation 230; however, the group of disparity images used for displaying the device stereoscopic image may be generated by the workstation 230 or may be generated by the terminal apparatus 240. For example, the workstation 230 may generate a group of disparity images containing both the subject and the medical device by superimposing an image of the medical device onto a group of disparity images of the subject. Alternatively, the terminal apparatus 240 may generate a group of disparity images containing both the subject and the medical device by superimposing an image of the medical device onto a group of disparity images of the subject generated by the workstation 230.

When an operation to move the device stereoscopic image is performed while the subject stereoscopic image and the device stereoscopic image are displayed on the stereoscopic display monitor 142, the receiving unit 2452 included in the terminal apparatus 240 obtains the coordinates within the stereoscopic image space at which the device stereoscopic image is positioned. More specifically, when the viewer has performed the operation to move the device stereoscopic image while using the input unit 141 such as a pointing device or the like, the receiving unit 2452 receives the coordinates within the stereoscopic image space indicating the position of the device stereoscopic image, from the input unit 141. After that, the receiving unit 2452 obtains the coordinates within the volume data space at which the device stereoscopic image is positioned by using the function “F” described above and further transmits the obtained coordinates within the volume data space to the workstation 230. Because the device stereoscopic image is a three-dimensional image occupying a certain region, it means that the receiving unit 2452 transmits a plurality of sets of coordinates indicating the region occupied by the device stereoscopic image, to the workstation 230.

Subsequently, when having received the coordinates of the device stereoscopic image within the volume data space from the terminal apparatus 240, the estimating unit 2351 included in the workstation 230 estimates positional changes of the voxels contained in the volume data. More specifically, on the assumption that the medical device is arranged to be in the position indicated by the coordinates of the device stereoscopic image received from the receiving unit 2452, the estimating unit 2351 estimates the positional changes (movement vectors and expansion rates) of the voxels in the volume data, based on various types of parameters “Y1” to “Y7” shown below, or the like.

Y1: an external force applied to the inside of the subject due to the insertion of the medical device
Y2: the CT value
Y3: the size and the shape of the medical device
Y4: the distance to the medical device
Y5: the CT value of an adjacent voxel
Y6: the blood flow velocity, the blood flow volume, and the blood pressure
Y7: information about the subject

First, “Y1” listed above will be explained. When having a medical device such as an endoscope or a scalpel inserted therein, various types of organs inside the subject receive an external force from the medical device. More specifically, because the various types of organs are pushed by the inserted medical device away from the original positions thereof, the various types of organs move in the directions to move away from the medical device. For this reason, when estimating the positional change of each of the voxels, the estimating unit 2351 uses the external force indicated as “Y1” above. The external force applied to each of the sites (the voxels) is calculated in advance based on the distance between the site (the voxel) and the medical device, the type of the medical device, and the like. The type of the medical device in this situation refers to an endoscope or a cutting tool such as a scalpel. For example, when the type of the medical device is a cutting tool, the movement amount is smaller because the organ is cut by the cutting tool. In contrast, when the type of the medical device is an endoscope, the movement amount is larger because the organ is pushed by the endoscope away from the original position thereof.

As explained for “X2” above, because the CT value listed as “Y2” above indicates the hardness of the organ, the CT value can be used as an index of the movement amount and the expansion rate of the organ itself. The parameter “Y3” listed above can be explained as follows: The larger the medical device is, the larger is the region occupied inside the subject, and the larger is the movement amount of the organ. On the contrary, with a slender and small medical device, because the region occupied inside the subject is smaller, the movement amount of the organ is also smaller.

For this reason, when estimating the positional change of each of the voxels, the estimating unit 2351 uses the size and the shape of the medical device indicated as “Y3” above. Further, the parameters “Y4” to “Y7” above are the same as the parameters “X4” to “X7” above.

By using a function that uses the various types of parameters “Y1” to “Y7” explained above as variables thereof, the estimating unit 2351 according to the second embodiment estimates the movement vectors and the expansion rates of the voxels in the volume data.

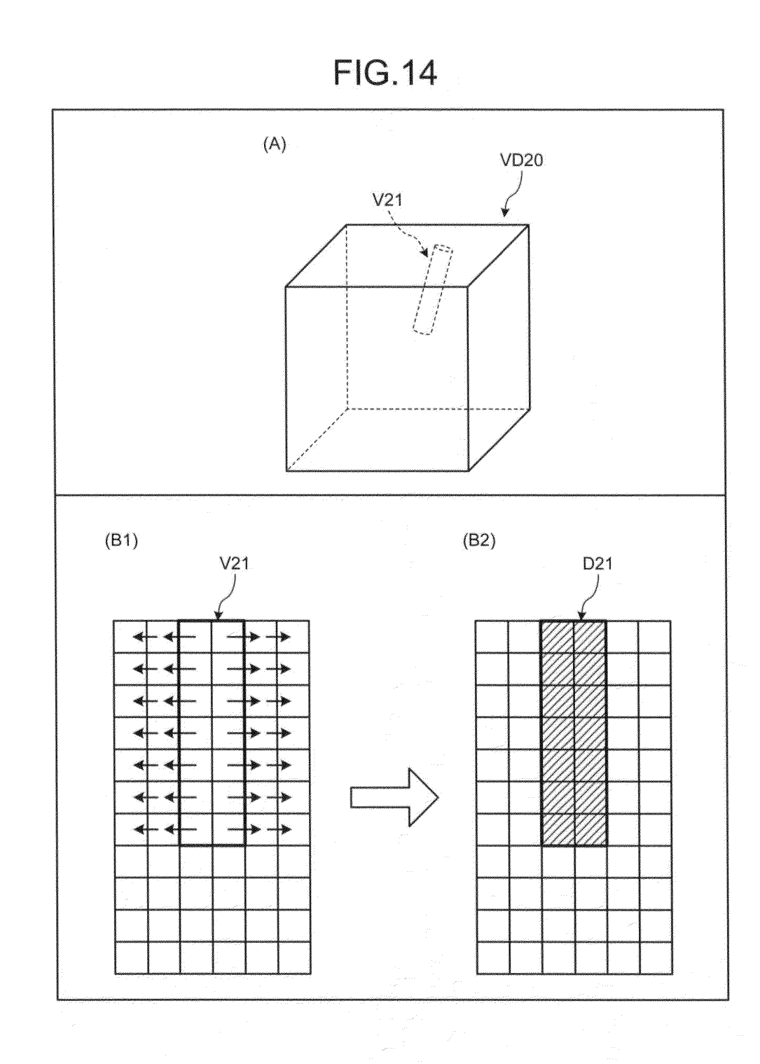

Next, an example of an estimating process performed by the estimating unit 2351 will be explained, with reference to FIG. 14. FIG. 14 is a drawing for explaining the example of the estimating process performed by the estimating unit 2351 according to the second embodiment. In the example shown in FIG. 14, the workstation 230 transmits a group of disparity images generated from volume data VD20 to the terminal apparatus 240. Thus, by displaying the group of disparity images received from the workstation 230, the terminal apparatus 240 displays a subject stereoscopic image and a device stereoscopic image such as those illustrated in FIG. 13(A) on the stereoscopic display monitor 142 and receives an operation to move the device stereoscopic image. In that situation, the terminal apparatus 240 obtains the coordinates within the volume data space at which the device stereoscopic image is positioned after the move. In the present example, let us assume that the terminal apparatus 240 obtains, as shown in the example in FIG. 14(A), the coordinates of a voxel region V21, as the coordinates within the volume data space at which the device stereoscopic image is positioned.

In that situation, by using the movement estimating function calculated from the parameters “Y1” to “Y7” explained above or the like, the estimating unit 2351 included in the workstation 230 estimates the movement vectors and the expansion rates of the voxels constituting the volume data VD20. FIG. 14(B1) illustrates a group of voxels positioned in the surroundings of the voxel region V21. An example of an estimating process performed on the group of voxels will be explained. In FIG. 14(B1), the region marked with the bold line is the voxel region V21, and it is indicated that the device stereoscopic image Ic21 has been arranged in the voxel region V21.

In the example shown in FIG. 14(B1), the estimating unit 2351 estimates that the voxels in the voxel region V21 and the voxels in the surroundings of the voxel region V21 will move in the directions to move away from the voxel region V21. In this manner, the estimating unit 2351 estimates the movement vectors of the voxels contained in the volume data VD20. Further, although not shown in FIG. 14, the estimating unit 2351 also estimates the expansion rates of the voxels.

Subsequently, the rendering controlling unit 2352 included in the workstation 230 generates virtual volume data by causing the movement vectors and the expansion rates of the voxels estimated by the estimating unit 2351 to be reflected on the volume data and further controls the rendering processing unit 136 so as to perform a rendering process on the generated virtual volume data.

Next, a virtual volume data generating process performed by the rendering controlling unit 2352 will be explained with reference to the example shown in FIG. 14. As shown in FIG. 14(B1), the rendering controlling unit 2352 first changes the positional arrangements of the voxels in the volume data VD20, based on the movement vectors and the expansion rates of the voxels estimated by the estimating unit 2351. Further, the rendering controlling unit 2352 replaces CT values of the voxels in the voxel region V21 with a CT value representing the medical device (metal or the like), as shown in a region D21 indicated with hatching in FIG. 14(B2). The rendering controlling unit 2352 thus generates the virtual volume data.

The group of disparity images newly generated by the rendering processing unit 136 is transmitted to the terminal apparatus 240 by the display controlling unit 1353. Thus, by displaying the transmitted group of disparity images on the stereoscopic display monitor 142, the display controlling unit 2451 included in the terminal apparatus 240 displays the stereoscopic image I22 containing the stereoscopic image Ic22 representing the medical device, as shown in FIG. 13(B).

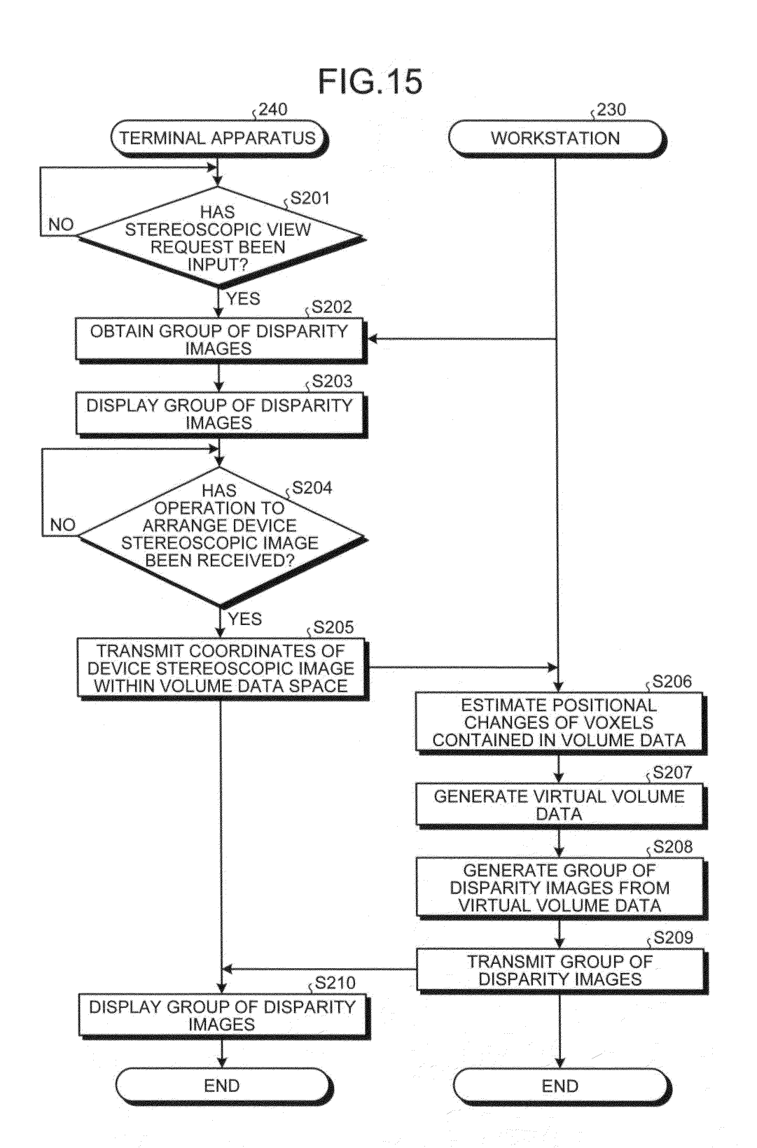

Next, an exemplary flow in a process performed by the workstation 230 and the terminal apparatus 240 according to the second embodiment will be explained, with reference to FIG. 15. FIG. 15 is a sequence chart of the exemplary flow in the process performed by the image processing system according to the second embodiment.

As shown in FIG. 15, the terminal apparatus 240 judges whether a stereoscopic view request has been input from the viewer (step S201). In this situation, if no stereoscopic view request has been input (step S201: No), the terminal apparatus 240 stands by.

On the contrary, if a stereoscopic view request has been input (step S201: Yes), the terminal apparatus 240 obtains a group of disparity images corresponding to the received stereoscopic view request, from the workstation 230 (step S202). After that, the display controlling unit 2451 displays the group of disparity images obtained from the workstation 230, on the stereoscopic display monitor 142 (step S203). In this situation, by superimposing an image of the medical device onto the group of disparity images of the subject, the workstation 230 generates a group of disparity images containing both the subject and the medical device and transmits the generated group of disparity images to the terminal apparatus 240. Alternatively, the workstation 230 may generate a group of disparity images of the subject that does not contain the image of the medical device and transmits the generated group of disparity images to the terminal apparatus 240. In that situation, by superimposing an image of the medical device onto the group of disparity images of the subject received from the workstation 230, the terminal apparatus 240 generates a group of disparity images containing both the subject and the medical device.

Subsequently, the receiving unit 2452 included in the terminal apparatus 240 judges whether an operation has been received, the operation indicating that a device stereoscopic image should be arranged into the stereoscopic image space that is displayed on the stereoscopic display monitor 142 and in which the subject stereoscopic image is being displayed (step S204). In this situation, if such an operation to arrange the device stereoscopic image has not been received (step S204: No), the receiving unit 2452 stands by until such an arranging operation is received.

On the contrary, when such an operation to arrange the device stereoscopic image has been received (step S204: Yes), the receiving unit 2452 obtains the coordinates within the volume data space corresponding to the coordinates of the device stereoscopic image within the stereoscopic image space by using the function “F” explained above and transmits the obtained coordinates of the device stereoscopic image within the volume data space to the workstation 230 (step S205).

After that, on the assumption that the medical device is arranged at the coordinates of the device stereoscopic image received from the terminal apparatus 240, the estimating unit 2351 included in the workstation 230 estimates positional changes (movement vectors and expansion rates) of the voxels in the volume data, based on the various types of parameters “Y1” to “Y7” described above or the like (step S206).

Subsequently, the rendering controlling unit 2352 generates virtual volume data by causing the movement vectors and the expansion rates of the voxels estimated by the estimating unit 2351 to be reflected on the volume data (step S207). After that, the rendering controlling unit 2352 generates a group of disparity images by controlling the rendering processing unit 136 so as to perform a rendering process on the virtual volume data (step S208). Further, the display controlling unit 1353 transmits the group of disparity images generated by the rendering processing unit 136 to the terminal apparatus 240 (step S209).

The display controlling unit 2451 included in the terminal apparatus 240 displays the group of disparity images received from the workstation 230, on the stereoscopic display monitor 142 (step S210). The stereoscopic display monitor 142 is thus able to display the stereoscopic image showing the state inside the subject in the situation where the medical device is inserted.

As explained above, according to the second embodiment, it is possible to display the stereoscopic image showing the state of the inside of the subject after the medical device is inserted. As a result, the viewer (e.g., the medical doctor) is able to recognize, prior to the surgical operation using the medical device, the positional relationship among the various types of organs of which the positions change due to the insertion of the medical device. Further, for example, by changing the insertion position of the medical device and/or the type of the medical device, the viewer (e.g., the medical doctor) is able to check the state of the inside the subject as many times as necessary. Thus, the viewer is able to determine, prior to the surgical operation, the insertion position of the medical device and the type of the medical device that are suitable for the surgical operation.

The second embodiment is not limited to the exemplary embodiments described above and may be implemented in various modes including a number of modification examples described below. In the following sections, modification examples of the second embodiment will be explained.

Other Medical Devices and Estimation of the Movement of Each of the Organs

In the second embodiment described above, the example is explained in which only the one medical device having a circular columnar shape is displayed, as shown in FIG. 13(A). However, another arrangement is acceptable in which the terminal apparatus 240 displays a plurality of medical devices so that the viewer is able to select one of the medical devices to be moved. Further, in the second embodiment described above, the example is explained in which, as shown in FIG. 13, the medical device is inserted into the subject; however, the terminal apparatus 240 may be configured so as to receive an operation to pinch or pull a blood vessel while using a medical device such as tweezers or an operation to make an incision on the surface of an organ while using a scalpel or medical scissors. Further, in the second embodiment described above, the example is explained in which the movement vector and the expansion rate are estimated for each of the voxels; however, another arrangement is acceptable in which the workstation 230 extracts organs such as the heart, the lungs, blood vessels, and the like that are contained in the volume data by performing a segmentation process on the volume data and further estimates a movement vector and an expansion rate in units of organs that are extracted. Further, when generating the virtual volume data, the workstation 230 may exercise control so that groups of voxels representing mutually the same organ are positioned adjacent to one another.

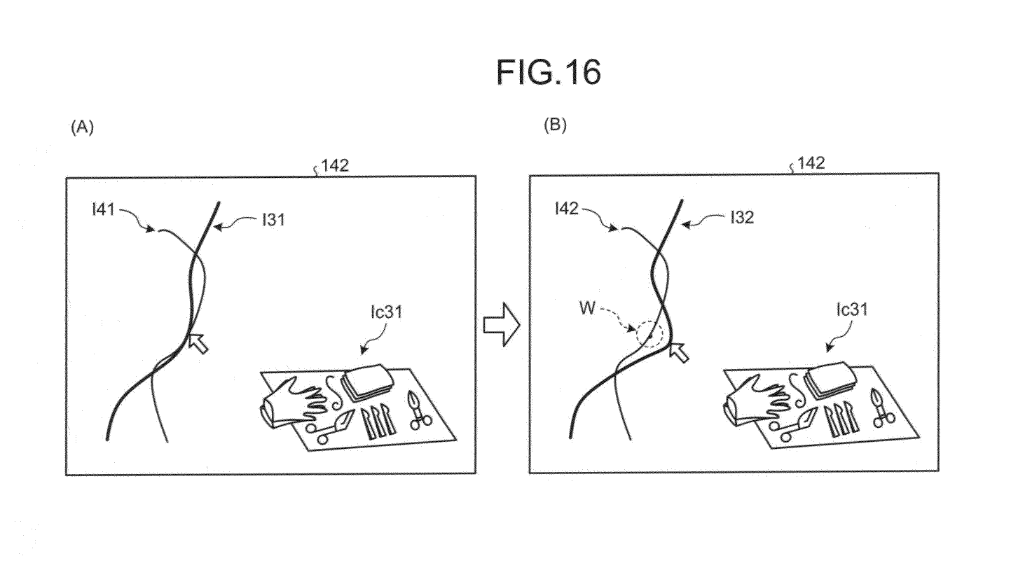

These aspects will be further explained with reference to a specific example shown in FIG. 16. FIG. 16 is a drawing for explaining a modification example of the second embodiment. In the example shown in FIG. 16(A), the terminal apparatus 240 displays stereoscopic images I31 and I41 showing blood vessels of the subject and also displays a stereoscopic image Ic31 showing a plurality of medical devices. As for each of the medical devices displayed in the stereoscopic image Ic31, the function thereof such as an external force applied by the medical device to an organ is set in advance. For example, the tweezers are set to have a function of moving together with an organ pinched thereby. Further, as a result of a segmentation process, the workstation 230 extracts the blood vessel shown by the stereoscopic image I31 and the blood vessel shown by the stereoscopic image I32 as two separate blood vessels. In other words, when generating virtual volume data, the workstation 230 arranges the voxels in such a manner that the stereoscopic image I31 and the stereoscopic image I32 each showing a single organ do not get divided into sections. By selecting a desired medical device out of the stereoscopic image Ic31 by using a pointing device or the like while such stereoscopic images are being displayed, the viewer is able to perform various types of operations on the stereoscopic image I31 or I41 while using the selected medical device.

In the present example, let us discuss a situation where the viewer clicks on the tweezers shown in the stereoscopic image Ic31 and subsequently performs an operation to move the stereoscopic image I31. Let us also assume that, as mentioned above, the tweezers are set to have the function of moving together with an organ pinched thereby. In this situation, the rendering controlling unit 2352 generates virtual volume data by estimating a positional change of each of the organs, based on the function with which the tweezers are set and the various types of parameters “Y1” to “Y7” described above or the like. At that time, the rendering controlling unit 2352 not only moves the stereoscopic image I31 manipulated with the tweezers, but also estimates whether other organs (e.g., the blood vessel shown by the stereoscopic image I41) will move due to the movement of the blood vessel shown by the stereoscopic image I31. As a result of the terminal apparatus 240 displaying a group disparity images generated from such virtual volume data, as shown in the example in FIG. 16(B), the viewer is able to view the stereoscopic image I32 showing the blood vessel after the move and is further able to view a stereoscopic image I42 showing another blood vessel affected by the movement of the blood vessel. In addition, even if a plurality of stereoscopic images overlap one another, the viewer is able to move the stereoscopic image of each of the organs. Thus, the viewer is able to find, for example, an aneurysm W, as shown in the example in FIG. 16(B).

Display of a Virtual Endoscope

In the second embodiment described above, the example is explained in which, as shown in FIG. 13(B), the appearance of the inside of the subject into which the medical device such as an endoscope is inserted is displayed as the stereoscopic image. In that situation, when the stereoscopic image of the endoscope has been arranged to be positioned on the inside of the subject as shown in FIG. 13, a stereoscopic image of the inside of the subject captured by the endoscope may be displayed together with the appearance of the subject. More specifically, the stereoscopic image of the inside of the subject captured by the endoscope may be displayed by using a virtual endoscopy (VE) display method, which is widely used as a method (CT Colonography [CTC]) for displaying three-dimensional X-ray CT images obtained by capturing images of the large intestine or the like.

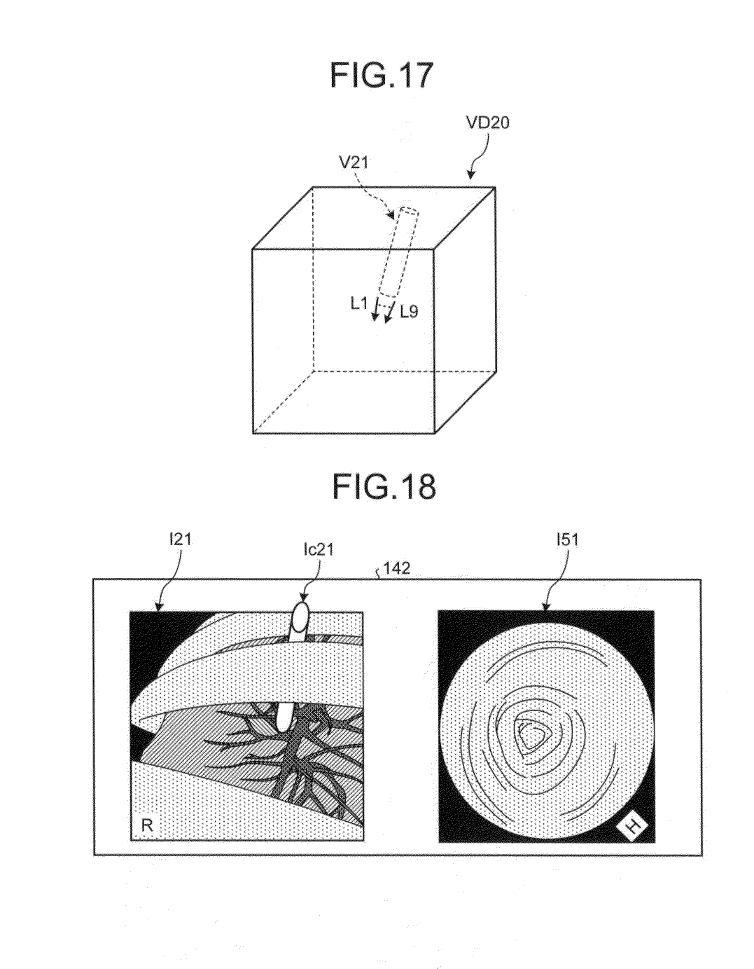

When the virtual endoscopy display method is applied to the second embodiment described above, the rendering controlling unit 2352 controls the rendering processing unit 136 so as to set a plurality of viewpoint positions at a tip end portion of the virtual endoscope represented by a device stereoscopic image and to perform a rendering process while using the plurality of viewpoint positions. This process will be explained more specifically, with reference to FIGS. 17 and 18. FIGS. 17 and 18 are drawings for explaining a modification example of the second embodiment. Like FIG. 13, FIG. 18 illustrates an example in which a medical device such as an endoscope or a scalpel is inserted into a space between ribs. Similarly to the example shown in FIG. 14, in the volume data VD20 shown in FIG. 17, the device stereoscopic image showing the endoscope is arranged to be in the voxel region V21. In the example shown in FIG. 17, the rendering controlling unit 2352 generates a group of disparity images, while using nine viewpoint positions L1 to L9 positioned at the tip end portion of the virtual endoscope as a rendering condition. After that, the workstation 230 transmits a group of disparity images showing the appearance of the inside of the subject, together with a group of disparity images captured from the virtual endoscope, to the terminal apparatus 240. With this arrangement, as shown in the example in FIG. 18, the terminal apparatus 240 is able to display a stereoscopic image I51 of the inside of the subject captured by the virtual endoscope, together with the appearance of the inside of the subject into which the device stereoscopic image (the endoscope) Ic21 is inserted. As a result, the viewer is able to recognize, prior to the surgical operation, what kind of picture will be captured by the endoscope in correspondence with the extent to which the endoscope is inserted.

Further, in the second embodiment described above, the example is explained in which the endoscope is inserted into the subject as the medical device. Generally speaking, during an actual medical procedure, after an endoscope is inserted into a subject, air may be injected into the subject from the endoscope. Thus, the terminal apparatus 240 according to the second embodiment may be configured to receive an operation to inject air, after the operation to insert the endoscope into the subject is performed. Further, when having received the operation to inject air, the terminal apparatus 240 notifies the workstation 230 that the operation has been received. When being notified by the terminal apparatus 240, the workstation 230 generates virtual volume data by estimating positional changes (movement vectors and expansion rates) of the voxels in the volume data, based on the various types of parameters “Y1” to “Y7” described above or the like, on the assumption that air is injected from a tip end of the endoscope. After that, the workstation 230 generates a group of disparity images by performing a rendering process on the virtual volume data and transmits the generated group of disparity images to the terminal apparatus 240. As a result, the terminal apparatus 240 is able to display a stereoscopic image showing the state of the inside of the subject into which air has been injected from the endoscope after the insertion of the endoscope.

Settings of Opacity

As explained above, the workstation 230 is capable of extracting the organs such as the heart, the lungs, blood vessels, and the like contained in the volume data, by performing the segmentation process on the volume data. In that situation, the workstation 230 may be configured so as to be able to set opacity for each of the extracted organs. With this arrangement, even if a plurality of stereoscopic images overlap one another, because it is possible to set opacity for each of the organs, the viewer is able to, for example, look at only a blood vessel or to look at only myocardia.

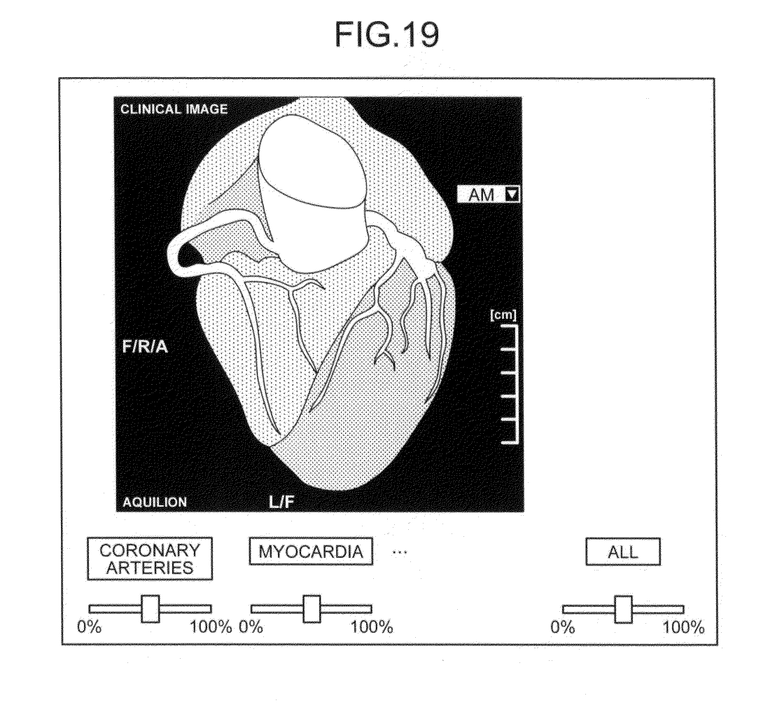

This aspect will be explained more specifically, with reference to FIG. 19. FIG. 19 is a drawing for explaining yet another modification example of the second embodiment. As shown in the example in FIG. 19, the terminal apparatus 240 displays control bars that make it possible to set opacity for each of the sites. The images of the control bars are, for example, superimposed on the group of disparity images by the terminal apparatus 240. When the slider of any of the control bars is moved by using a pointing device or the like, the terminal apparatus 240 transmits the opacity of each of the organs after the change, to the workstation 230. Based on the opacity of each of the organs received from the terminal apparatus 240, the workstation 230 performs a rendering process on the volume data and transmits a generated group of disparity images to the terminal apparatus 240. As a result, the terminal apparatus 240 is able to display a stereoscopic image in which the opacity of each of the organs is changeable. The properties that are changeable for each of the organs are not limited to the opacity. It is acceptable to configure the terminal apparatus 240 so as to be able to change the density of the color or the like for each of the organs, by using a control bar such as those in the example described above.

Automatic Setting of Opacity

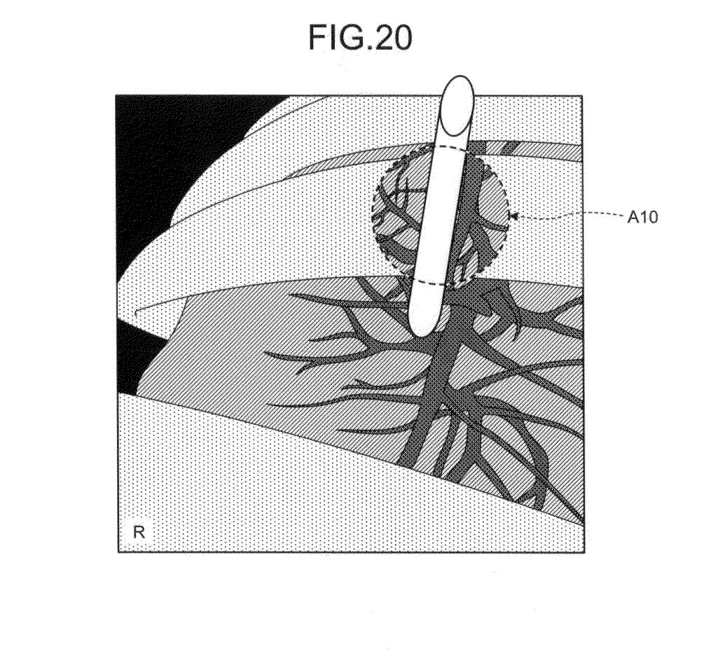

When the medical device such as an endoscope is inserted into the stereoscopic image of the inside of the subject as shown in the examples with the stereoscopic image I21 in FIGS. 13 and 18, there is a possibility that a part of the medical device may be hidden behind another organ (the “bone” in the examples with the stereoscopic image I21). To cope with this situation, it is acceptable to configure the workstation 230 so as to automatically lower the opacity of the region near the inserted medical device. This process will be explained while using the examples shown in FIGS. 14 and 20. FIG. 20 is a drawing for explaining yet another modification example of the second embodiment.

In the example shown in FIG. 14(A), the workstation 230 performs a rendering process on the volume data VD20, for example, after automatically lowering the opacity of the voxels positioned near the voxel region V21. As a result, as shown in the example in FIG. 20, the terminal apparatus 240 displays, for instance, a stereoscopic image in which a region A10 near the medical device is transparent. Consequently, the viewer is able to accurately observe the impact that will be made on the surrounding organs by the insertion of the medical device.

### Third Embodiment

The exemplary embodiments described above may be modified into other embodiments. Modification examples of the exemplary embodiments described above will be explained as a third embodiment.

In the exemplary embodiments described above, the example is explained in which the medical image diagnosis apparatus is an X-ray CT apparatus. However, as mentioned above, the medical image diagnosis apparatus may be an MRI apparatus or may be an ultrasound diagnosis apparatus. In those situations, the CT Value “X2”, the CT value of an adjacent voxel “X5”, the CT value “Y2”, and the CT value of an adjacent voxel “Y5” may be the strength of an MR signal kept in correspondence with each pulse sequence or may be reflected-wave data of ultrasound waves. Further, when the medical image diagnosis apparatus is an MRI apparatus or an ultrasound diagnosis apparatus, it is possible to display an elasticity image such as elastography by measuring the elasticity (hardness) of a tissue in the subject's body while applying pressure to the tissue from the outside. For this reason, when the medical image diagnosis apparatus is an MRI apparatus or an ultrasound diagnosis apparatus, the estimating unit 1351 and the estimating unit 2351 may estimate the positional changes of the voxels in the volume data, based on the elasticity (the hardness) of the tissues in the subject's body obtained from the elastography, in addition to the various types of parameters “X1” to “X7” or “Y1” to “Y7” described above.

Constituent Elements that Perform the Processes

In the exemplary embodiments described above, the example is explained in which the terminal apparatus 140 or 240 obtains the group of disparity images corresponding to the movement thereof or corresponding to the shifting of the viewing positions, from the workstation 130 or 230. However, the terminal apparatus 140 may have the same functions as those of the controlling unit 135, the rendering processing unit 136, and the like included in the workstation 130, whereas the terminal apparatus 240 may have the same functions as those of the controlling unit 235, the rendering processing unit 136, and the like included in the workstation 230. In that situation, the terminal apparatus 140 or 240 obtains the volume data from the image storing apparatus 120 and performs the same processes as those performed by the controlling unit 135 or 235 described above.

Further, in the exemplary embodiments described above, instead of configuring the workstation 130 or 230 to generate the group of disparity images from the volume data, the medical image diagnosis apparatus 110 may have a function equivalent to that of the rendering processing unit 136 so as to generate the group of disparity images from the volume data. In that situation, the terminal apparatus 140 or 240 obtains the group of disparity images from the medical image diagnosis apparatus 110.

The Number of Disparity Images

In the exemplary embodiments described above, the example is explained in which the display is realized by superimposing the shape image onto the group of disparity images mainly made up of nine disparity images; however, the exemplary embodiments are not limited to this example. For example, another arrangement is acceptable in which the workstation 130 generates a group of disparity images made up of two disparity images.

System Configuration

Of the processes explained in the exemplary embodiments, it is acceptable to manually perform all or a part of the processes described as being performed automatically, and it is acceptable to automatically perform, while using a publicly-known method, all or a part of the processes described as being performed manually. In addition, the processing procedures, the controlling procedure, the specific names, and the information including the various types of data and parameters that are described and indicated in the above text and the drawings may be arbitrarily modified unless noted otherwise.

The constituent elements of the apparatuses that are shown in the drawings are based on functional concepts. Thus, it is not necessary to physically configure the elements as indicated in the drawings. In other words, the specific mode of distribution and integration of the apparatuses is not limited to the ones shown in the drawings. It is acceptable to functionally or physically distribute or integrate all or a part of the apparatuses in any arbitrary units, depending on various loads and the status of use. For example, the controlling unit 135 included in the workstation 130 may be connected to the workstation 130 via a network as an external apparatus.

Computer Programs

The processes performed by the terminal apparatus 140 or 240 and the workstation 130 or 230 described in the exemplary embodiments above may be realized as a computer program written in a computer-executable language. In that situation, it is possible to achieve the same advantageous effects as those of the exemplary embodiments described above, when a computer executes the computer program. Further, it is also acceptable to realize the same processes as those described in the exemplary embodiments by having such a computer program recorded on a computer-readable recording medium and causing a computer to read and execute the computer program recorded on the recording medium. For example, such a computer program may be recorded on a hard disk, a flexible disk (FD), a Compact Disk Read-Only Memory (CD-ROM), a Magneto-Optical (MO) disk, a Digital Versatile Disk (DVD), a Blu-ray disk, or the like. Further, such a computer program may be distributed via a network such as the Internet.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image processing system comprising:
a stereoscopic display apparatus configured to display a stereoscopic image capable of providing a stereoscopic view, by using a group of disparity images of a subject generated from volume data that is three-dimensional medical image data;
a receiving unit configured to receive an operation to apply a virtual force to the subject shown in the stereoscopic image;
an estimating unit configured to estimate positional changes of voxels contained in the volume data, based on the force received by the receiving unit;
a rendering processing unit configured to change positional arrangements of the voxels contained in the volume data based on a result of the estimation by the estimating unit and to newly generate a group of disparity images by performing a rendering process on post-change volume data; and
a display controlling unit configured to cause the stereoscopic display apparatus to display the group of disparity images newly generated by the rendering processing unit.

2. The image processing system according to claim 1, wherein
the receiving unit receives a setting of an incision region where a virtual incision is made on the subject expressed in the stereoscopic image, and
the estimating unit estimates the positional changes of the voxels contained in the volume data, by using an internal pressure that is a force having been applied to an inside of the subject by the incision region received by the receiving unit.

3. The image processing system according to claim 1, wherein
the stereoscopic display apparatus displays, together with the stereoscopic image of the subject, a stereoscopic image of a virtual medical device for which an external force to be applied thereby to the subject is set in advance,
the receiving unit receives an operation to apply a force to the subject shown in the stereoscopic image by using the virtual medical device, and
the estimating unit estimates the positional changes of the voxels contained in the volume data, by using the external force corresponding to the virtual medical device.

4. The image processing system according to claim 3, wherein
the receiving unit receives an operation to arrange a virtual endoscope serving as the virtual medical device into a three-dimensional space in which the stereoscopic image of the subject is being displayed,
the rendering processing unit newly generates a group of disparity images by performing a rendering process from an arbitrary viewpoint position on the post-change volume data obtained by changing the positional arrangements of the voxels based on a result of the estimation by the estimating unit, and further newly generates a group of disparity images by performing a rendering process on the post-change volume data by using a position of the virtual endoscope received by the receiving unit as a viewpoint position, and
the display controlling unit causes the stereoscopic display apparatus to display the group of disparity images that is generated by the rendering processing unit and corresponds to the arbitrary viewpoint position and the group of disparity images that is generated by using the virtual endoscope as the viewpoint position.

5. The image processing system according to claim 4, wherein the rendering processing unit performs the rendering process from the arbitrary viewpoint position, after lowering opacity of such voxels that are positioned near the position of the virtual endoscope, from among the voxels contained in the post-change volume data obtained by changing the positional arrangements of the voxels.

6. The image processing system according to claim 1, wherein
the estimating unit sets a plurality of incision regions in each of which a virtual incision is made on the subject expressed in the stereoscopic image and estimates the positional changes of the voxels contained in the volume data with respect to each of the plurality of incision regions,
the rendering processing unit newly generates a plurality of groups of disparity images corresponding to the incision regions set by the estimating unit, based on a result of the estimation by the estimating unit, and
the display controlling unit causes the stereoscopic display apparatus to display the plurality of groups of disparity images newly generated by the rendering processing unit.

7. The image processing system according to claim 6, wherein
from among the plurality of incision regions, the estimating unit selects one or more incision regions in which the positional changes of the voxels contained in the volume data are smaller than a predetermined threshold value, and
the rendering processing unit newly generates one or more groups of disparity images corresponding to the one or more incision regions selected by the estimating unit.

8. An image processing apparatus comprising:
a stereoscopic display apparatus configured to display a stereoscopic image capable of providing a stereoscopic view, by using a group of disparity images of a subject generated from volume data that is three-dimensional medical image data;
a receiving unit configured to receive an operation to apply a virtual force to the subject shown in the stereoscopic image;
an estimating unit configured to estimate positional changes of voxels contained in the volume data, based on the force received by the receiving unit;
a rendering processing unit configured to change positional arrangements of the voxels contained in the volume data based on a result of the estimation by the estimating unit and to newly generate a group of disparity images by performing a rendering process on post-change volume data; and
a display controlling unit configured to cause the stereoscopic display apparatus to display the group of disparity images newly generated by the rendering processing unit.

9. An image processing method implemented by an image processing system including a stereoscopic display apparatus configured to display a stereoscopic image capable of providing a stereoscopic view by using a group of disparity images of a subject generated from volume data that is three-dimensional medical image data, the image processing method comprising:
receiving an operation to apply a virtual force to the subject shown in the stereoscopic image;
estimating positional changes of voxels contained in the volume data, based on the received force;
changing positional arrangements of the voxels contained in the volume data based on a result of the estimation and newly generating a group of disparity images by performing a rendering process on post-change volume data; and
causing the stereoscopic display apparatus to display the newly-generated group of disparity images.

10. A medical image diagnosis apparatus comprising:
a stereoscopic display apparatus configured to display a stereoscopic image capable of providing a stereoscopic view, by using a group of disparity images of a subject generated from volume data that is three-dimensional medical image data;
a receiving unit configured to receive an operation to apply a virtual force to the subject shown in the stereoscopic image;
an estimating unit configured to estimate positional changes of voxels contained in the volume data, based on the force received by the receiving unit;
a rendering processing unit configured to change positional arrangements of the voxels contained in the volume data based on a result of the estimation by the estimating unit and to newly generate a group of disparity images by performing a rendering process on post-change volume data; and
a display controlling unit configured to cause the stereoscopic display apparatus to display the group of disparity images newly generated by the rendering processing unit.
